(19) United States
(12) Patent Application Publication
(10) Pub. No.: US 2024/0224275 A1
(43) Pub. Date: Jul. 4, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/607,581

(22) Filed: Mar. 18, 2024

Related U.S. Application Data
(63) Continuation of application No. PCT/CN2022/119606, filed on Sep. 19, 2022.

(30) Foreign Application Priority Data
Sep. 20, 2021 (CN) 202111102473.9
Sep. 30, 2021 (CN) 202111163360.X

(51) Int. Cl. H04W 72/1268; H04W 72/231; H04W 72/542; H04W 76/19

(52) U.S. Cl. CPC H04W 72/1268; H04W 72/231; H04W 72/542; H04W 76/19

(57) ABSTRACT

The communication node receives a first signaling, the first signaling indicating a first RS resource set, each RS resource group in the first RS resource set comprising at least one RS resource subgroup; for each RS resource subgroup, whenever a radio link quality is worse than a first-type threshold, increments a first-class counter by 1; receives a second signaling, the second signaling indicating a first uplink grant; transmits a target MAC CE according to the first uplink grant, the target MAC CE comprising at least one piece of BFR information, the first BFR information being associated with one piece of BFR information of a first RS resource subgroup, the first RS resource subgroup being one RS resource subgroup in a first RS resource group; whether there is one RS resource subgroup without BFR included in the first RS resource group is used to determine the first RS resource subgroup.

### CROSS REFERENCE TO RELATED APPLICATIONS

This application is the continuation of the international patent application No. PCT/CN2022/119606, filed on Sep. 19,2022, and claims the priority benefit of Chinese Patent Application No. 202111102473.9, filed on Sep. 20,2021, and claims the priority benefit of Chinese Patent Application No. 202111163360.X, filed on Sep. 30,2021, the full disclosure of which is incorporated herein by reference.

### BACKGROUND

### Technical Field

The present application relates to transmission methods and devices in wireless communication systems, and in particular to a method and a device for multi-beam transmission.

### Related Art

The 3rd Generation Partnership Project (3GPP) introduces a mechanism of Beam Failure Recovery (BFR) for the Special Cell (SpCell) in Release 15 (R15), and then a BFR mechanism for Secondary Cell (SCell) is introduced in R16. The triggering of a Radio Link Failure (RLF) at higher layers can be prevented through a BFR mechanism. A Work Item (WI) of “Further enhancements on Multiple Input Multiple Output (MIMO) for NR” has been decided at the 3GPP Radio Access Network (RAN) #80 conference to be conducted for enhancing the Multiple-Transmitter-and Receiver-Point (multi-TRP) BFR mechanism.

### SUMMARY

The BFR MAC CE of R16 includes a bitmap for indicating the cell (Ci field) in which a beam failure occurred, and for each SCell in which the beam failure occurred a byte may also be included for indicating beam failure information, the byte including an AC (i.e., availability indication) field, which indicates whether a Candidate RS ID field exists, when the Candidate RS ID field is present it is used to indicate a candidate RS ID, when it is absent, bits corresponding to the Candidate RS ID field are reserved. Due to the enhancements in Release 17 (R17) for the multi-TRP BFR mechanism, each TRP can independently perform the beam failure detection and recovery procedure, and each TRP is configured with a set of reference signal resources for beam failure detection as well as a corresponding set of candidate reference signal resources. The BFR MAC CE of R16 cannot indicate a beam failure for a single TRP, and when two TRPs have beam failures, if the beam failures for both TRPs are indicated in the enhanced BFR Media Access Control (MAC) Control Element (CE) of R17, how to determine the BFR information in R17 enhanced BFR MAC CE needs to be enhanced when the uplink grant is not sufficient for transmitting all the BFR information.

To address the above problem, the present application provides a solution. For the above problem description, the uu-interface scenario is used as an example; the present application is equally applicable to, for example, the sidelink scenario, to achieve similar technical effects as in the uu-interface scenario. Additionally, the adoption of a unified solution for various scenarios contributes to the reduction of hardcore complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:
receiving a first signaling, the first signaling indicating a first Reference Signal (RS) resource set, the first RS resource set comprising at least one RS resource group, each of the at least one RS resource group being associated with one cell, and each of the at least one RS resource group comprising at least one RS resource subgroup, each RS resource subgroup comprising at least one RS resource;
for each RS resource subgroup in the first RS resource set, whenever a radio link quality evaluated according to the each RS resource subgroup is worse than a first-type threshold, incrementing a first-class counter corresponding to the each RS resource subgroup by 1; determining whether to trigger a Beam Failure Recovery (BFR) according to whether the first-class counter corresponding to the each RS resource subgroup reaches a first-type value;
receiving a second signaling, the second signaling indicating a first uplink grant; and
transmitting a target MAC CE according to the first uplink grant, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set;
herein, there is at least one RS resource subgroup with BFR in each RS resource group in the first RS resource set; at least whether there is one RS resource subgroup without BFR included in the first RS resource group is used to determine the first RS resource subgroup.

In one embodiment, a problem to be solved in the present application includes: how to generate the target MAC CE.

In one embodiment, a problem to be solved in the present application includes: how to assemble the target MAC CE.

In one embodiment, a problem to be solved in the present application includes: how to determine the sorting order of BFR information in the target MAC CE.

In one embodiment, a problem to be solved in the present application includes: how to determine the priority of BFR information in the target MAC CE.

In one embodiment, a problem to be solved in the present application includes: how to determine the first BFR information in the target MAC CE.

In one embodiment, characteristics of the above method include: for the first cell group, in all RS resource subgroups that have BFRs, whether first BFR information is included in the target MAC CE is related to whether the first BFR information is a piece of cell-specific BFR information or a piece of TRP-specific BFR information.

In one embodiment, characteristics of the above method include: for the first cell group, in all RS resource subgroups that have BFRs, determining the first RS resource subgroup according to at least whether there is one RS resource subgroup without BFR included in the first RS resource group.

In one embodiment, characteristics of the above method include: all RS resources in the first RS resource set belonging to the first cell group.

In one embodiment, characteristics of the above method include: whether there is one RS resource subgroup without BFR included in an RS resource group is used to determine the order of BFR information in the target MAC CE.

In one embodiment, characteristics of the above method include: whether there is one RS resource subgroup without BFR included in the first RS resource group is used to determine a first piece of BFR information in the target MAC CE.

In one embodiment, an advantage of the above method includes: when the first uplink grant is insufficient, reporting the first BFR information whenever possible.

In one embodiment, an advantage of the above method includes: in the target MAC CE, the order of the BFR information is related to whether each of the at least one RS resource group includes one RS resource subgroup without BFR.

In one embodiment, an advantage of the above method includes: if an RS resource group includes one RS resource subgroup without BFR and another RS resource group does not include one RS resource subgroup without BFR, the BFR information in one RS resource group precedes the BFR information in the other RS resource group in the target MAC CE.

According to one aspect of the present application, characterized in that a number of RS resource subgroups in the first RS resource group is used to determine the first RS resource subgroup.

In one embodiment, characteristics of the above method include: the number of RS resource subgroups included in an RS resource group is used to determine the order of BFR information in the target MAC CE.

In one embodiment, characteristics of the above method include: the order of BFR information in the target MAC CE is related to the number of RS resource subgroups included in an RS resource group.

In one embodiment, characteristics of the above method include: in the target MAC CE, the order of BFR information is related to the number of RS resource subgroups included in each of the at least one RS resource group.

In one embodiment, characteristics of the above method include: in the target MAC CE, the order of the BFR information is related to whether each of the at least one RS resource group includes one RS resource subgroup without BFR, and the order of BFR information is related to the number of RS resource subgroups included in each of the at least one RS resource group.

According to one aspect of the present application, characterized in that a cell identifier of a cell associated with the first RS resource group is used to determine the first RS resource subgroup.

In one embodiment, characteristics of the above method include: the order of BFR information in the target MAC CE is related to a cell identifier of the cell associated with each of the at least one RS resource group.

In one embodiment, characteristics of the above method include: in the target MAC CE, the order of the BFR information is related to whether each of the at least one RS resource group includes one RS resource subgroup without BFR, and the order of BFR information is related to a cell identifier of the cell associated with each of the at least one RS resource group.

In one embodiment, characteristics of the above method include: in the target MAC CE, the order of the BFR information is related to whether each of the at least one RS resource group includes one RS resource subgroup without BFR, and the order of BFR information is related to the number of RS resource subgroups included in each of the at least one RS resource group, and the order of BFR information is related to a cell identifier of the cell associated with each of the at least one RS resource group.

In one embodiment, characteristics of the above method include: for any two pieces of the at least one piece of BFR information, determining the first RS resource subgroup in accordance with whether or not there is one RS resource subgroup without BFR is included in each RS resource group; if each RS resource group includes one RS resource subgroup without BFR, or each RS resource group does not include an RS resource subgroup without BFR, determining the first RS resource subgroup in accordance with a number of RS resource subgroups included in each RS resource group; if the number of RS resource subgroups included in each RS resource group is equal, determining the first RS resource group in accordance with the cell identifier of the cell associated with each RS resource group.

In one embodiment, characteristics of the above method include: for any two pieces of the at least one piece of BFR information, determining the first RS resource subgroup in accordance with whether or not there is one RS resource subgroup without BFR is included in each RS resource group; if each RS resource group includes one RS resource subgroup without BFR, or each RS resource group does not include an RS resource subgroup without BFR, determining the first RS resource group in accordance with the cell identifier of the cell associated with each RS resource group.

According to one aspect of the present application, characterized in that the first BFR information is a last piece of BFR information in the at least one piece of BFR information; resources granted by the first uplink grant can contain up to Q pieces of BFR information, Q being a positive integer, Q being used to determine the first RS resource subgroup.

According to one aspect of the present application, characterized in that the first BFR information is a piece of BFR information at any given position in the at least one piece of BFR information.

According to one aspect of the present application, characterized in that the target MAC CE comprises a first bitmap, a first bit in the first bitmap indicates the first RS resource subgroup or the first bit in the first bitmap indicates a cell associated with the first RS resource group.

According to one aspect of the present application, characterized in that the first BFR information comprises at least one of a first field, a second field or a third field; the first field in the first BFR information is used to indicate whether the second field in the first BFR information exists, if the first field in the first BFR information indicates that the second field in the first BFR information exists, the second field in the first BFR information indicates a first RS resource, the first RS resource being associated with the first RS resource subgroup; if the first field in the first BFR information indicates that the second field in the first BFR information does not exist, the second field in the first BFR information is reserved; the third field in the first BFR information is reserved or the third field in the first BFR information is used to indicate the first RS resource subgroup.

The present application provides a method in a second node for wireless communications, comprising:
transmitting a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; and
transmitting a second signaling, the second signaling indicating a first uplink grant; and
receiving a target MAC CE, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set;
herein, for each RS resource subgroup in the first RS resource set, whenever a radio link quality evaluated according to the each RS resource subgroup is worse than a first-type threshold, a first-class counter corresponding to the each RS resource subgroup is incremented by 1; it is determined whether a BFR is to be triggered according to whether the first-class counter corresponding to the each RS resource subgroup reaches a first-type value; the target MAC CE is transmitted according to the first uplink grant; there is at least one RS resource subgroup with BFR in each RS resource group in the first RS resource set; at least whether there is one RS resource subgroup without BFR included in the first RS resource group is used to determine the first RS resource subgroup.

According to one aspect of the present application, characterized in that a number of RS resource subgroups in the first RS resource group is used to determine the first RS resource subgroup.

According to one aspect of the present application, characterized in that a cell identifier of a cell associated with the first RS resource group is used to determine the first RS resource subgroup.

According to one aspect of the present application, characterized in that the first BFR information is a last piece of BFR information in the at least one piece of BFR information; resources granted by the first uplink grant can contain up to Q pieces of BFR information, Q being a positive integer, Q being used to determine the first RS resource subgroup.

According to one aspect of the present application, characterized in that the first BFR information is a piece of BFR information at any given position in the at least one piece of BFR information.

According to one aspect of the present application, characterized in that the target MAC CE comprises a first bitmap, a first bit in the first bitmap indicates the first RS resource subgroup or the first bit in the first bitmap indicates a cell associated with the first RS resource group.

According to one aspect of the present application, characterized in that the first BFR information comprises at least one of a first field, a second field or a third field; the first field in the first BFR information is used to indicate whether the second field in the first BFR information exists, if the first field in the first BFR information indicates that the second field in the first BFR information exists, the second field in the first BFR information indicates a first RS resource, the first RS resource being associated with the first RS resource subgroup; if the first field in the first BFR information indicates that the second field in the first BFR information does not exist, the second field in the first BFR information is reserved; the third field in the first BFR information is reserved or the third field in the first BFR information is used to indicate the first RS resource subgroup.

The present application provides a first node for wireless communications, comprising:
a first receiver, receiving a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; for each RS resource subgroup in the first RS resource set, whenever a radio link quality evaluated according to the each RS resource subgroup is worse than a first-type threshold, incrementing a first-class counter corresponding to the each RS resource subgroup by 1; determining whether to trigger a Beam Failure Recovery (BFR) according to whether the first-class counter corresponding to the each RS resource subgroup reaches a first-type value; and receiving a second signaling, the second signaling indicating a first uplink grant; and
a first transmitter, transmitting a target MAC CE according to the first uplink grant, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set;
herein, there is at least one RS resource subgroup with BFR in each RS resource group in the first RS resource set; at least whether there is one RS resource subgroup without BFR included in the first RS resource group is used to determine the first RS resource subgroup.

According to one aspect of the present application, characterized in that a number of RS resource subgroups in the first RS resource group is used to determine the first RS resource subgroup.

The present application provides a second node for wireless communications, comprising:
a second transmitter, transmitting a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; and transmitting a second signaling, the second signaling indicating a first uplink grant; and
a second receiver, receiving a target MAC CE, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set;
herein, for each RS resource subgroup in the first RS resource set, whenever a radio link quality evaluated according to the each RS resource subgroup is worse than a first-type threshold, a first-class counter corresponding to the each RS resource subgroup is incremented by 1; it is determined whether a BFR is to be triggered according to whether the first-class counter corresponding to the each RS resource subgroup reaches a first-type value; the target MAC CE is transmitted according to the first uplink grant; there is at least one RS resource subgroup with BFR in each RS resource group in the first RS resource set; at least whether there is one RS resource subgroup without BFR included in the first RS resource group is used to determine the first RS resource subgroup.

In one embodiment, compared with the prior art, the present application is advantageous in the following aspects:
determining BFR information in the target MAC CE based on the number of RS resource subgroups included in the RS resource group, the cell identifier of the associated cell, and whether or not an RS resource subgroup without BFR is included, in order to optimize the BFR reporting mechanism.
determining the order of BFR information in the target MAC CE based on the number of RS resource subgroups included in the RS resource group, the cell identifier of the associated cell, and whether or not an RS resource subgroup without BFR is included, in order to optimize the BFR reporting mechanism.
when the first uplink grant is insufficient, reporting the first BFR information whenever possible.
optimizing the system performance.
determine the BFR information to be sent based on demand.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first signaling, a second signaling and a target MAC CE according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a schematic diagram of a number of RS resource subgroups in the first RS resource group being used to determine a first RS resource subgroup according to one embodiment of the present application.

FIG. 7 illustrates a schematic diagram of a cell identifier of a cell associated with a first RS resource group being used to determine a first RS resource subgroup according to one embodiment of the present application.

FIG. 8 illustrates a schematic diagram of first BFR information being a piece of BFR information at any given position in the at least one piece of BFR information according to one embodiment of the present application.

FIG. 9 illustrates a schematic diagram of a location of first BFR information according to one embodiment of the present application.

FIG. 10 illustrates a schematic diagram of first BFR information being a last piece of BFR information in the at least one piece of BFR information according to one embodiment of the present application.

FIG. 11 illustrates a schematic diagram of a target MAC CE comprising a first bitmap according to one embodiment of the present application.

FIG. 12 illustrates a schematic diagram of a first bitmap according to one embodiment of the present application.

FIG. 13 illustrates a schematic diagram of a first bitmap according to another embodiment of the present application.

FIG. 14 illustrates a schematic diagram of a first bitmap according to a third embodiment of the present application.

FIG. 15 illustrates a schematic diagram of a first bitmap according to a fourth embodiment of the present application.

FIG. 16 illustrates a schematic diagram of each piece of BFR information in the at least one piece of BFR information in a target MAC CE comprising at least one of a first field or a second field or a third field according to one embodiment of the present application.

FIG. 17 illustrates a schematic diagram of first BFR information comprising a first field, a second field and a third field according to one embodiment of the present application.

FIG. 18 illustrates a schematic diagram of a target MAC CE comprising the first bitmap and at least one piece of BFR information according to one embodiment of the present application.

FIG. 19 illustrates a schematic diagram of sorting order of at least one piece of BFR information in a target MAC CE according to one embodiment of the present application.

FIG. 20 illustrates a structure block diagram of a processing device used in a first node according to one embodiment of the present application.

FIG. 21 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

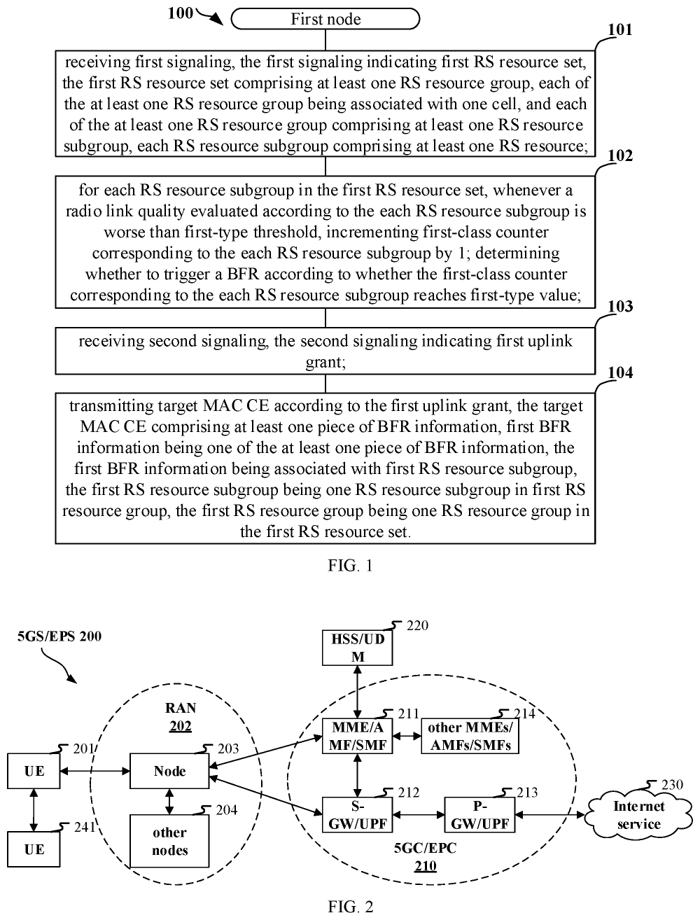

Embodiment 1 illustrates a flowchart of transmission of a first signaling, a second signaling and a target MAC CE according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first signaling in step 101, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; and in step 102, for each RS resource subgroup in the first RS resource set, whenever a radio link quality evaluated according to the each RS resource subgroup is worse than a first-type threshold, increments a first-class counter corresponding to the each RS resource subgroup by 1; determines whether to trigger a Beam Failure Recovery (BFR) according to whether the first-class counter corresponding to the each RS resource subgroup reaches a first-type value; and in step 103, receives a second signaling, the second signaling indicating a first uplink grant; and in step 104, transmits a target MAC CE according to the first uplink grant, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set; herein, there is at least one RS resource subgroup with BFR in each RS resource group in the first RS resource set; at least whether there is one RS resource subgroup without BFR included in the first RS resource group is used to determine the first RS resource subgroup.

In one embodiment, the first signaling is used to configure the first RS resource set.

In one embodiment, the first signaling is used to determine the first RS resource set.

In one embodiment, the first signaling implicitly indicates the first RS resource set.

In one embodiment, the first signaling explicitly indicates the first RS resource set.

In one embodiment, the first signaling is used to determine an index of each RS resource in the first RS resource set.

In one embodiment, the first signaling indicates an index of each RS resource in the first RS resource set.

In one embodiment, the first signaling comprises a Downlink (DL) signaling.

In one embodiment, the first signaling comprises a Sidelink (SL) signaling.

In one embodiment, the first signaling is a Radio Resource Control (RRC) message.

In one embodiment, the first signaling comprises at least one RRC message.

In one embodiment, the first signaling comprises at least one Information Element (IE) in an RRC message.

In one embodiment, the first signaling comprises at least one Field in an RRC message.

In one embodiment, the first signaling comprises a RRCReconfiguration message.

In one embodiment, the first signaling comprises a System Information Block 1 (SIB1) message. In one embodiment, the first signaling comprises a SystemInformation message.

In one embodiment, the first signaling is a field or an IE other than an IE RadioLinkMonitoringConfig.

In one embodiment, the first signaling comprises at least one IE other than an IE RadioLinkMonitoringConfig.

In one embodiment, the first signaling comprises M sub-signalings, of which each sub-signaling comprises an IE RadioLinkMonitoringConfig, M being a number of Bandwidth Parts (BWPs).

In one embodiment, the first signaling comprises at least an IE RadioLinkMonitoringConfig.

In one embodiment, the first signaling comprises at least a failureDetectionResourcesToAddModList field.

In one embodiment, the first signaling is a failureDetection ResourcesToAddModList field.

In one embodiment, at least one IE or at least one field in the first signaling other than an IE RadioLinkMonitoringConfig indicates the first RS resource set.

In one embodiment, the first RS resource set belongs to the first cell group.

In one embodiment, the first RS resource set and the second RS resource set both belong to the first cell group.

In one embodiment, the first cell group is a Master Cell Group (MCG).

In one embodiment, the first cell group is a Secondary Cell Group (SCG).

In one embodiment, the cell is a serving cell in the first cell group, the serving cell including a Special Cell (SpCell) or a SCell.

In one embodiment, the SpCell refers to a Primary Cell (PCell) or a Primary Secondary Cell Group (SCG) Cell, i.e., PSCell.

In one embodiment, the cell is a SCell.

In one embodiment, the cell is identified by a ServCellIndex.

In one embodiment, the ServCellIndex of the cell is an integer no less than 1 and no greater than 31.

In one embodiment, each RS resource group in the first RS resource set is associated with a SCell in the first cell group.

In one embodiment, each RS resource group in the first RS resource set is associated with a serving cell in the first cell group.

In one embodiment, the first RS resource subgroup is determined from the first RS resource set.

In one embodiment, the first RS resource subgroup is determined from a subset of the first RS resource set.

In one embodiment, an index of each RS resource in the first RS resource set is directly or indirectly obtained via the first signaling.

In one embodiment, the first RS resource set comprises one or more RS resource groups.

In one embodiment, the number of RS resource groups in the first RS resource set is variable.

In one embodiment, the number of RS resource groups in the first RS resource set is pre-configured.

In one embodiment, the number of RS resource groups included in the first RS resource set is related to the number of RS resource groups with BFRs in all cells in the first cell group.

In one embodiment, the number of RS resource groups included in the first RS resource set is related to the number of RS resource groups with BFRs in all cells other than the SpCell in the first cell group.

In one embodiment, if at least one RS resource subgroup in one RS resource group has a BFR, the RS resource group is an RS resource group with BFR.

In one embodiment, the number of RS resource groups in the first RS resource set is not greater than 7.

In one embodiment, the number of RS resource groups in the first RS resource set is not greater than 8.

In one embodiment, the number of RS resource groups in the first RS resource set is not greater than 31.

In one embodiment, the number of RS resource groups in the first RS resource set is not greater than 32.

In one embodiment, the number of RS resource groups in the first RS resource set is not greater than 63.

In one embodiment, the number of RS resource groups in the first RS resource set is not greater than 64.

In one embodiment, the at least two RS resource subgroups in each RS resource group in the first RS resource set belong to a same Bandwidth Part (BWP).

In one embodiment, the at least two RS resource subgroups in each RS resource group in the first RS resource set belong to Active Bandwidth Part (BWP).

In one embodiment, the at least two RS resource subgroups in each RS resource group in the first RS resource set belong to a same Physical Cell identifier (PCI).

In one embodiment, the at least two RS resource subgroups in each RS resource group in the first RS resource set belong to different PCIs.

In one embodiment, all RS resource subgroups in each RS resource group in the first RS resource set are associated with a same cell.

In one embodiment, all RS resource subgroups in each RS resource group in the first RS resource set are associated with different cells.

In one embodiment, a number of RS resource subgroup(s) in each RS resource group in the first RS resource set is configurable.

In one embodiment, a number of RS resource subgroup(s) in each RS resource group in the first RS resource set is pre-configured.

In one embodiment, any two RS resource groups in the first RS resource set comprise equal numbers of RS resource subgroups.

In one embodiment, any two RS resource groups in the first RS resource set comprise equal or unequal numbers of RS resource subgroups.

In one embodiment, each RS resource group in the first RS resource set includes at least one RS resource subgroup.

In one embodiment, each RS resource group in the first RS resource set includes one RS resource subgroup or two RS resource subgroups.

In one embodiment, each RS resource group in the first RS resource set includes two RS resource subgroups.

In one embodiment, all RS resources included in an RS resource subgroup belong to a same TRP.

In one embodiment, at least one RS resource included in an RS resource subgroup is used in a link recovery procedure.

In one embodiment, at least one RS resource included in an RS resource subgroup is used to determine if a beam failure has occurred.

In one embodiment, at least one RS resource included in an RS resource subgroup is used for Beam Failure Detection.

In one embodiment, an RS resource subgroup is used for link recovery procedures.

In one embodiment, at least one RS resource included in an RS resource subgroup corresponds to a

In one embodiment, an RS resource subgroup corresponds to a q̅₀.

In one embodiment, an RS resource subgroup is a q̅₀.

In one embodiment, a name of an RS resource subgroup includes q̅₀.

In one embodiment, an RS resource subgroup is determined by failureDetectionResources or beam FailureDetectionResourceList.

In one embodiment, an RS resource subgroup is determined according to a reference signal set indicated in a corresponding Transmission Configuration Indicator (TCI) state of a Control resource set (CORESET) used for listening over the Physical Downlink Control Channel (PDCCH).

In one embodiment, an RS resource subgroup is determined by the first node.

In one embodiment, the phrase “each of the at least one RS resource group being associated with one cell” includes that: each of the at least one RS resource group belongs to one cell.

In one embodiment, any two RS resource groups among the at least one RS resource group belong to two different cells.

In one embodiment, a cell with which one RS resource group of the at least one RS resource group is associated has a different ServCellIndex than a cell with which the other RS resource group is associated.

In one embodiment, the first RS resource set includes PI RS resource group(s), each of the P1 RS resource group(s) is associated with one cell, and the PI RS resource group(s) is(are) associated with P1 cell(s).

In one subembodiment, P1 is equal to 1.

In one subembodiment, P1 is greater than 1, and any two of the P1 RS resource groups are associated with different cells.

In one subembodiment, P1 is not greater than a number of configured SCells in the first cell group.

In one subembodiment, P1 is no greater than 31.

In one embodiment, one RS resource in an RS resource subgroup is a Channel state information Reference Signal (CSI-RS) resource.

In one embodiment, one RS resource in an RS resource subgroup is a Synchronization Signal Block (SSB) resource.

In one embodiment, one RS resource in an RS resource subgroup is a Synchronization Signal (SS)/Physical Broadcast Channel (PBCH) block.

In one embodiment, any RS resource in an RS resource subgroup is periodic.

In one embodiment, any RS resource in an RS resource subgroup is aperiodic.

In one embodiment, any RS resource in an RS resource subgroup is quasi-colocation(QCL)-Type D.

In one embodiment, one RS resource in an RS resource subgroup is a CSI-RS resource identified by csi-RS-Index, or the RS resource is an SSB resource identified by ssb-Index.

In one embodiment, one RS resource in an RS resource subgroup is a CSI-RS resource identified by csi-rs, or the RS resource is an SSB resource identified by ssb.

In one embodiment, one RS resource in an RS resource subgroup is a CSI-RS resource identified by NZP-CSI-RS-ResourceId, or the RS resource is an SSB resource identified by SSB-Index.

In one embodiment, that a radio link quality evaluated according to one RS resource subgroup is worse than a first-type threshold triggers incrementing the first-class counter corresponding to the RS resource subgroup by 1; where the RS resource subgroup belongs to the first RS resource set.

In one embodiment, only if a radio link quality evaluated according to one RS resource subgroup is worse than a first-type threshold will the first-class counter corresponding to the RS resource subgroup be incremented by 1; if a radio link quality evaluated according to the RS resource subgroup is not worse than a first-type threshold, the first-class counter corresponding to the RS resource subgroup is not incremented by 1.

In one embodiment, if a radio link quality evaluated according to one RS resource subgroup is worse than a first-type threshold, reporting to upper layers a first-type indication, only upon reception of the first-type indication at the upper layers will the first-class counter corresponding to the RS resource subgroup be incremented by 1.

In one embodiment, if one RS resource subgroup is reconfigured by a higher layer, the first-class counter corresponding to the RS resource subgroup is set to 0.

In one embodiment, if a beam failure recovery timer associated with the first-class counter expires, the first-class counter corresponding to the RS resource subgroup is set to 0.

In one embodiment, the meaning of whenever includes: once, or as long as, or if.

In one embodiment, the phrase that a radio link quality evaluated according to the each RS resource subgroup is worse than a first-type threshold comprises; the radio link quality for all RS resources in each RS resource subgroup is worse than the first-type threshold.

In one embodiment, the phrase that a radio link quality evaluated according to the each RS resource subgroup is worse than a first-type threshold comprises: the radio link quality for each RS resource in each RS resource subgroup is lower than the first-type threshold.

In one embodiment, the phrase that a radio link quality evaluated according to the each RS resource subgroup is worse than a first-type threshold comprises: the radio link quality for each RS resource in each RS resource subgroup is higher than the first-type threshold.

In one embodiment, the radio link quality is evaluated according to one RS resource group during each first-type evaluation period.

In one embodiment, the first-type evaluation period of the radio link quality comprises at least 1 Slot.

In one embodiment, the slot comprises at least one of slot(s), or subframe(s), or Radio Frame(s), or frame(s), or multiple Orthogonal Frequency Division Multiplexing (OFDM) symbols, or multiple Single Carrier Frequency Division Multiple Access (SC-FDMA) symbols.

In one embodiment, the slot comprises a time interval of at least 1 millisecond (ms).

In one embodiment, the evaluation period of the radio link quality is 1 Frame.

In one embodiment, the evaluation period of the radio link quality is 1 Radio Frame.

In one embodiment, the first-type threshold is configurable.

In one embodiment, the first-type threshold is pre-configured.

In one embodiment, the first-type threshold is configured via an RRC message.

In one embodiment, the first-type threshold includes a Block Error Ratio (BLER) threshold.

In one embodiment, the first-type threshold includes a Reference Signal Received Power (RSRP) threshold.

In one embodiment, the first-type threshold comprises Qₒᵤₜ.

In one embodiment, the first-type threshold is indicated by a field in an RRC message.

In one embodiment, the first-type threshold is indicated by a field in an RRC message, where a name of the field includes rlmInSyncOutOfSyncThreshold.

In one embodiment, the first-type threshold is indicated by a field in an RRC message, where a name of the field includes rsrp-ThresholdSSB.

In one embodiment, the first-type threshold is indicated by a field in an RRC message, where a name of the field includes rsrp-ThresholdBFR.

In one embodiment, whenever a radio link quality evaluated according to one RS resource subgroup is worse than a first-type threshold, reporting a first-type indication for the RS resource subgroup to a target higher layer during a first-type reporting period corresponding to the first-type evaluation period corresponding to the RS resource subgroup.

In one embodiment, the first-type reporting period comprises at least 1 slot.

In one embodiment, the first-type reporting period is 2 ms.

In one embodiment, the first-type reporting period is 10 ms.

In one embodiment, the first-type reporting period is a shortest period for all RS resources in the RS resource subgroup.

In one embodiment, the action of reporting a first-type indication to a target higher layer includes: the PHY layer of the first node transmits the first-type indication to the target higher layer of the first node via an interlayer interface.

In one embodiment, the action of reporting a first-type indication to a target higher layer includes: transmitting one first-type indication to the target higher layer.

In one embodiment, the action of reporting a first-type indication to a target higher layer includes: notifying the target higher layer of the first-type indication.

In one embodiment, the first-type indication is used to indicate to the target higher layer a beam failure.

In one embodiment, the first-type indication is a beam failure instance indication.

In one embodiment, whenever a radio link quality evaluated according to one RS resource subgroup is worse than a first-type threshold, a physical layer of the first node reports to a target higher layer of the first node a first-type indication corresponding to the RS resource subgroup, and as a response to reception of the first-type indication corresponding to the RS resource subgroup at the target higher layer of the first node, the first-class counter corresponding to the RS resource subgroup is incremented by 1.

In one embodiment, the action of “the first-class counter incremented by 1” comprises: increasing the count value of the first-class counter by 1.

In one embodiment, the action of “the first-class counter incremented by 1” comprises: incrementing the first-class counter by 1.

In one embodiment, the first-class counter is used for counting a number of the first-type indications.

In one embodiment, a name of the first-class counter includes BFI_COUNTER.

In one embodiment, a name of the first-class counter includes at least one of BFI (i.e., Beam Failure Indication) or COUNTER or TRP or RS or Set or per.

In one embodiment, the first-class counter is for one cell.

In one embodiment, the first-class counter is for a TRP in one cell.

In one embodiment, the first-type value is a positive integer.

In one embodiment, the first-type value is a non-negative integer.

In one embodiment, the first-type value is not greater than 512.

In one embodiment, the first-type value is not greater than 10.

In one embodiment, the first-type value is equal to a beamFailureInstanceMaxCount.

In one embodiment, the first-type value is equal to the value of a parameter, a name of the parameter including at least one of beam or Failure or Instance or Max or Count or TRP or RS or Set or per.

In one embodiment, for different RS resource subgroups, there exist at least two RS resource subgroups with the first-type thresholds being configured as different values.

In one embodiment, any two RS resource subgroups among all RS resource subgroups in the first RS resource set and the second RS resource set are configured with the first-type thresholds that are the same.

In one embodiment, there are two RS resource subgroups among all RS resource subgroups in the first RS resource set and the second RS resource set being configured with the first-type thresholds that are different.

In one embodiment, each RS resource subgroup is configured with one first-type threshold.

In one embodiment, each RS resource subgroup is configured with one first-class counter.

In one embodiment, each RS resource subgroup is configured with one first-type value.

In one embodiment, the first-type threshold that each RS resource subgroup is configured with is configurable.

In one embodiment, the first-type value that each RS resource subgroup is configured with is configurable.

In one embodiment, any two RS resource subgroups are configured with the first-type thresholds that are the same.

In one embodiment, there are at least two RS resource subgroups being configured with the first-type thresholds that are different.

In one embodiment, any two RS resource subgroups are configured with the first-type values that are the same.

In one embodiment, there are at least two RS resource subgroups being configured with the first-type values that are different.

In one embodiment, two RS resource subgroups in a same RS resource group are configured with the first-type thresholds that are the same.

In one embodiment, two RS resource subgroups in a same RS resource group are configured with the first-type thresholds that are different.

In one embodiment, determining whether a BFR corresponding to each RS resource subgroup is triggered based on whether the first-class counter corresponding to each RS resource subgroup has reached a first-type value.

In one embodiment, a first-class counter reaching a first-type value means: the first-class counter is equal to or greater than the first-type value.

In one embodiment, a first-class counter reaching a first-type value means: the first-class counter is not less than the first-type value.

In one embodiment, if a first-class counter corresponding to one RS resource subgroup reaches a first-type value, a BFR for the RS resource subgroup is triggered; if a first-class counter corresponding to one RS resource subgroup does not reach a first-type value, a BFR for the RS resource subgroup is not triggered.

In one embodiment, only when a first-class counter corresponding to one RS resource subgroup reaches a first-type value will a BFR corresponding to the RS resource subgroup be triggered.

In one embodiment, the second signaling is used to determine the first uplink grant.

In one embodiment, the first uplink grant is a UL grant.

In one embodiment, the first uplink grant is dynamically scheduled on a PDCCH via the second signaling, the second signaling comprising one piece of Downlink control information (DCI).

In one embodiment, the first uplink grant is received in a second signaling, the second signaling comprising a Random Access Response (RAR).

In one embodiment, the first uplink grant is configured semi-persistently by the second signaling, the second signaling comprising an RRC message.

In one embodiment, the first uplink grant is determined to be associated with the PUSCH (i.e., Physical Uplink Shared Channel) resource of MSGA, the PUSCH associated with the MSGA being configured by the second signaling.

In one embodiment, the second signaling comprises an RRC message.

In one embodiment, the second signaling comprises a RRCReconfiguration message.

In one embodiment, the second signaling comprises at least one IE in an RRC message.

In one embodiment, the second signaling comprises at least one field in an RRC message.

In one embodiment, the second signaling comprises at least one MAC Protocol Data Unit (PDU).

In one embodiment, the second signaling comprises at least one MAC subPDU.

In one embodiment, the second signaling comprises at least one MAC subheader.

In one embodiment, the second signaling comprises at least one MAC RAR.

In one embodiment, the second signaling comprises at least one fallbackRAR.

In one embodiment, the second signaling comprises at least one PDCCH.

In one embodiment, the second signaling comprises at least one DCI.

In one embodiment, the at least one piece of BFR information includes only the first BFR information.

In one embodiment, the at least one piece of BFR information includes the first BFR information and at least one piece of BFR information other than the first BFR information.

In one embodiment, a size of one of the at least one piece of BFR information is equal to 1 byte, each byte comprising 8 bits.

In one embodiment, a size of one of the at least one piece of BFR information is equal to 2 bytes, each byte comprising 8 bits.

In one embodiment, the action “transmitting a target MAC CE according to the first uplink grant” comprises: transmitting the target MAC CE based on the size of resources granted by the first uplink grant.

In one embodiment, the action “transmitting a target MAC CE according to the first uplink grant” comprises: transmitting the target MAC CE based on the type of the first uplink grant.

In one embodiment, the action “transmitting a target MAC CE according to the first uplink grant” comprises: transmitting the target MAC CE on the resources granted by the first uplink grant.

In one embodiment, the action “transmitting a target MAC CE according to the first uplink grant” comprises: transmitting a MAC PDU based on the first uplink grant, the MAC PDU including the target MAC CE.

In one embodiment, a name of the target MAC CE includes BFR MAC CE.

In one embodiment, a name of the target MAC CE includes Truncated and BFR MAC CE.

In one embodiment, a name of the target MAC CE includes at least one of BFR MAC CE, or Truncated, or TRP or RS or Set or per.

In one embodiment, the target MAC CE comprises 1 piece of BFR information or more than 1 piece of BFR information.

In one embodiment, the number of pieces of BFR information included in the target MAC CE is related to the first uplink grant.

In one embodiment, the number of pieces of BFR information included in the target MAC CE is related to a Logical Channel Prioritization (LCP) procedure.

In one embodiment, the number of pieces of BFR information included in the target MAC CE is related to the presence of a MAC CE or MAC Service data unit (SDU) that has a higher order of Logical Channel Prioritization (LCP) than the target MAC CE.

In one embodiment, one piece of BFR information is associated with one RS resource subgroup.

In one embodiment, if an RS resource group includes an RS resource subgroup without BFR, the RS resource group includes 1 piece of BFR information: if an RS resource group does not include an RS resource subgroup without BFR and the number of RS resource subgroup(s) in the RS resource group is equal to 1, the RS resource group includes 1 piece of BFR information: if an RS resource group does not include an RS resource subgroup without BFR and the number of RS resource subgroup(s) in the RS resource group is equal to 2, the RS resource group includes 2 pieces of BFR information.

In one embodiment, the target MAC CE is transmitted on an Uplink shared channel (UL-SCH).

In one embodiment, the target MAC CE belongs to a MAC subPDU.

In one embodiment, the target MAC CE belongs to a MAC PDU.

In one embodiment, a MAC PDU including the target MAC CE includes only the target MAC CE.

In one embodiment, a MAC PDU including the target MAC CE includes the target MAC CE and a Cell Radio Network Temporary Identifier (C-RNTI) MAC CE.

In one embodiment, a MAC PDU including the target MAC CE includes the target MAC CE and a MAC PDU including the target MAC CE includes at least one of a MAC SDU or a MAC CE or a MAC subheader.

In one subembodiment, the MAC CE is not used to indicate a BFR.

In one subembodiment, a Logical Channel Identifier (LCID) in the MAC CE is not equal to 50 or 51.

In one subembodiment, an Extended Logical Channel ID (eLCID) in the MAC CE is not equal to 250 or 251.

In one embodiment, the phrase the first BFR information being associated with a first RS resource subgroup comprises: a measurement for the first RS resource subgroup is used to determine a first BFR, the first BFR being used to determine that the target MAC CE comprises the first BFR information.

In one embodiment, the phrase the first BFR information being associated with a first RS resource subgroup comprises: the first BFR information comprises a first candidate RS resource, the first candidate RS resource being a candidate RS resource in the first candidate RS resource group, the first candidate RS resource group being associated with the first RS resource subgroup, the first candidate RS resource group being a first-type candidate RS resource group.

In one embodiment, the phrase the first BFR information being associated with a first RS resource subgroup comprises: the first BFR information comprises an AC field, the AC field in the first BFR information indicating whether the first BFR indicates a candidate RS resource, the candidate RS resource being a candidate RS resource in the first candidate RS resource group, the first candidate RS resource group is associated with the first RS resource subgroup.

In one embodiment, each RS resource subgroup is associated with a first-type candidate RS resource group, the first-type candidate RS resource group comprising at least one candidate RS resource.

In one embodiment, the candidate RS resource is an SSB.

In one embodiment, the candidate RS resource is a CSI-RS.

In one embodiment, for each RS resource subgroup, a first-type candidate RS resource group is configured.

In one embodiment, there is one-to-one correspondence between an RS resource subgroup and a first-type candidate RS resource group.

In one embodiment, an RS resource subgroup and a first-type candidate RS resource group being associated with the RS resource subgroup are configured in a same IE.

In one embodiment, an RS resource subgroup and a first-type candidate RS resource group being associated with the RS resource subgroup have a same identifier.

In one embodiment, an RS resource subgroup and a first-type candidate RS resource group being associated with the RS resource subgroup belong to a same cell.

In one embodiment, an RS resource subgroup and a first-type candidate RS resource group being associated with the RS resource subgroup belong to a same TRP in the same cell.

In one embodiment, the first-type candidate RS resource group is configured via an RRC message.

In one embodiment, the above RRC message comprises the first signaling.

In one embodiment, the above RRC message comprises one RRC message other than the first signaling.

In one embodiment, one RS resource in the first candidate RS resource set is configured via a field of an RRC message, the field's name including CandidateBeamRS.

In one embodiment, one RS resource in the first-type candidate RS resource group comprises an SSB indexed by an SSB-Index configured via CandidateBeamRS.

In one embodiment, one RS resource in the first-type candidate RS resource group comprises a CSI-RS indexed by NZP-CSI-RS-ResourceId configured via CandidateBeamRS.

In one embodiment, the first candidate RS resource set is configured via a field of an RRC message, the field's name including candidateBeamRSSCellList.

In one embodiment, the first candidate RS resource set is configured via an IE of an RRC message, the IE's name including BeamFailureRecovery SCellConfig.

In one embodiment, the phrase that “the first RS resource subgroup is an RS resource subgroup in a first RS resource group” comprises: the first RS resource group includes an RS resource subgroup, the first RS resource subgroup being the first RS resource group.

In one embodiment, the phrase that “the first RS resource subgroup is an RS resource subgroup in a first RS resource group” comprises: the first RS resource group includes at least two RS resource subgroups, the first RS resource subgroup being one of the at least two RS resource subgroups in the first RS resource group.

In one embodiment, the phrase that “the first RS resource subgroup is an RS resource subgroup in a first RS resource group” comprises: the first RS resource group includes an RS resource subgroup, the first RS resource subgroup being the first RS resource group: or, the first RS resource group includes two RS resource subgroups, the first RS resource subgroup being one of the two RS resource subgroups in the first RS resource group.

In one embodiment, if the first RS resource group comprises at least two RS resource subgroups, and the first RS resource group comprises one RS resource subgroup without BFR, the first RS resource subgroup is an RS resource subgroup that has a BFR in the first RS resource group.

In one embodiment, if the first RS resource group comprises at least two RS resource subgroups, and each RS resource subgroup in the first RS resource group has a BFR, the first RS resource subgroup is an RS resource subgroup with an RS resource subgroup index being equal to 0 in the first RS resource group.

In one embodiment, if the first RS resource group comprises at least two RS resource subgroups, and each RS resource subgroup in the first RS resource group has a BFR, the first RS resource subgroup is an RS resource subgroup being associated with a serving cell in the first RS resource group.

In one subembodiment, two RS resource subgroups in the first RS resource group are respectively associated with a serving cell and an additional cell: where the additional cell has a PCI different from that of the serving cell.

In one subembodiment, the serving cell is configured with a ServCellIndex, while the additional cell is not configured with a ServCellIndex.

In one embodiment, if the first RS resource group comprises at least two RS resource subgroups, and each RS resource subgroup in the first RS resource group has a BFR, the first RS resource subgroup is an RS resource subgroup with an RS resource subgroup index being equal to 0 in the first RS resource group.

In one embodiment, if the first RS resource group comprises at least two RS resource subgroups, and each RS resource subgroup in the first RS resource group has a BFR, the first RS resource subgroup is an RS resource subgroup with the highest priority in the first RS resource group.

In one embodiment, if the first RS resource group comprises at least two RS resource subgroups, and each RS resource subgroup in the first RS resource group has a BFR, the first RS resource subgroup is an RS resource subgroup with a smallest RS resource subgroup index in the first RS resource group.

In one embodiment, if the first RS resource group comprises at least two RS resource subgroups, and each RS resource subgroup in the first RS resource group has a BFR, the first RS resource subgroup is an RS resource subgroup with a largest RS resource subgroup index in the first RS resource group.

In one embodiment, if the first RS resource group comprises at least two RS resource subgroups, and each RS resource subgroup in the first RS resource group has a BFR, the first RS resource subgroup is an RS resource subgroup associated with a TRP configured with PUCCH resources for SR in the first RS resource group.

In one embodiment, if the first RS resource group comprises at least two RS resource subgroups, and each RS resource subgroup in the first RS resource group has a BFR, the first RS resource subgroup is an RS resource subgroup associated with a TRP configured with CSS in the first RS resource group.

In one embodiment, if the first RS resource group comprises at least two RS resource subgroups, and each RS resource subgroup in the first RS resource group has a BFR, the first RS resource subgroup is any RS resource subgroup in the first RS resource group.

In one embodiment, if the first RS resource group comprises only one RS resource subgroup, and the first RS resource group has a BFR, the first RS resource subgroup is the first RS resource group.

In one embodiment, if the first RS resource group comprises only one RS resource subgroup, and the first RS resource group has a BFR, the first RS resource subgroup is any RS resource subgroup in the first RS resource group.

In one embodiment, an RS resource subgroup's index is one of 0 or 1.

In one embodiment, an RS resource subgroup's index is pre-configured.

In one embodiment, an RS resource subgroup's index is used to indicate the RS resource subgroup.

In one embodiment, the phrase that “there is at least one RS resource subgroup with BFR in each RS resource group in the first RS resource set” comprises: each RS resource group in the first RS resource set includes only one RS resource subgroup, the RS resource subgroup having a BFR.

In one embodiment, the phrase that “there is at least one RS resource subgroup with BFR in each RS resource group in the first RS resource set” comprises: each RS resource group in the first RS resource set includes two RS resource subgroups, either of the two RS resource subgroups having a BFR or each of the two RS resource subgroups having a BFR.

In one embodiment, the phrase that “there is at least one RS resource subgroup with BFR in each RS resource group in the first RS resource set” comprises: if one RS resource group in the first RS resource set includes only one RS resource subgroup, the RS resource subgroup has a BFR; if one RS resource group in the first RS resource set includes two RS resource subgroups, one of the two RS resource subgroups has a BFR or each of the two RS resource subgroups has a BFR; where one RS resource group in the first RS resource set includes only one RS resource subgroup or one RS resource group in the first RS resource set includes two RS resource subgroups.

In one embodiment, one RS resource subgroup with BFR means: at least the first-class counter being associated with the RS resource subgroup reaches the first-type value.

In one embodiment, one RS resource subgroup with BFR means: a BFR being associated with the RS resource subgroup is triggered in response to that the first-class counter being associated with the RS resource subgroup reaches the first-type value.

In one embodiment, one RS resource subgroup with BFR means: a beam failure is detected for the RS resource subgroup, and an evaluation for a candidate beam associated with the RS resource subgroup is completed.

In one embodiment, one RS resource subgroup with BFR means: at least for the RS resource subgroup a beam failure is detected.

In one embodiment, one RS resource subgroup with BFR means: at least for the RS resource subgroup a beam failure is detected and an evaluation is completed for candidate RS resources in the first-type candidate RS resource group associated with the RS resource subgroup.

In one embodiment, an evaluation is performed for candidate RS resources in the first-type candidate RS resource group being associated with the RS resource subgroup according to the requirements of at least R17 and its evolved 3GPP TS38.133.

In one embodiment, an evaluation is performed for candidate RS resources in the first-type candidate RS resource group being associated with the RS resource subgroup by means of SS-RSRP measurement.

In one embodiment, an evaluation is performed for candidate RS resources in the first-type candidate RS resource group being associated with the RS resource subgroup by means of CSI-RSRP measurement.

In one embodiment, if only one RS resource subgroup is included in an RS resource group, the RS resource group having a BFR means that the RS resource subgroup has a BFR.

In one embodiment, the phrase that “whether there is one RS resource subgroup without BFR included in the first RS resource group is used to determine the first RS resource subgroup” includes: determining the first RS resource subgroup according to whether the first RS resource group includes one RS resource subgroup without BFR.

In one subembodiment, if there exists at least one RS resource group in the first RS resource set comprising one RS resource subgroup without BFR, the first RS resource group is an RS resource group of the at least one RS resource group in the first RS resource set; the first RS resource subgroup is an RS resource subgroup in the first RS resource group.

In one subembodiment, if there exists at least one RS resource group in the first RS resource set not comprising one RS resource subgroup without BFR, the first RS resource group is an RS resource group of the at least one RS resource group in the first RS resource set: the first RS resource subgroup is an RS resource subgroup in the first RS resource group.

In one embodiment, the phrase that “at least whether there is one RS resource subgroup without BFR included in the first RS resource group is used to determine the first RS resource subgroup” includes: the first RS resource subgroup is an RS resource subgroup in an RS resource group comprising one RS resource subgroup without BFR in the first RS resource set.

In one embodiment, the phrase that “at least whether there is one RS resource subgroup without BFR included in the first RS resource group is used to determine the first RS resource subgroup” includes: the first RS resource subgroup is an RS resource subgroup in an RS resource group not comprising one RS resource subgroup without BFR in the first RS resource set.

In one embodiment, the phrase that “at least whether there is one RS resource subgroup without BFR included in the first RS resource group is used to determine the first RS resource subgroup” includes: whether the first RS resource group includes one RS resource subgroup without BFR is used to determine the first RS resource subgroup.

In one embodiment, the phrase that “at least whether there is one RS resource subgroup without BFR included in the first RS resource group is used to determine the first RS resource subgroup” includes: the first RS resource group including one RS resource subgroup without BFR is used to determine the first RS resource subgroup.

In one embodiment, the phrase that “at least whether there is one RS resource subgroup without BFR included in the first RS resource group is used to determine the first RS resource subgroup” includes: the first RS resource group not including one RS resource subgroup without BFR is used to determine the first RS resource subgroup.

In one embodiment, the phrase that “at least whether there is one RS resource subgroup without BFR included in the first RS resource group is used to determine the first RS resource subgroup” includes: if the first RS resource group includes an RS resource subgroup without BFR and a second RS resource group does not include an RS resource subgroup without BFR, the first RS resource subgroup is an RS resource subgroup in the first RS resource group.

In one embodiment, the phrase that “at least whether there is one RS resource subgroup without BFR included in the first RS resource group is used to determine the first RS resource subgroup” includes: if the first RS resource group does not include an RS resource subgroup without BFR and a second RS resource group includes an RS resource subgroup without BFR, the first RS resource subgroup is an RS resource subgroup in the first RS resource group.

In one embodiment, the phrase that “at least whether there is one RS resource subgroup without BFR included in the first RS resource group is used to determine the first RS resource subgroup” includes: whether each RS resource group in the first RS resource set includes one RS resource subgroup without BFR is used to determine the first RS resource subgroup.

In one embodiment, the phrase that “at least whether there is one RS resource subgroup without BFR included in the first RS resource group is used to determine the first RS resource subgroup” includes: whether each RS resource group among RS resource groups respectively comprising more than one RS resource subgroup in the first RS resource set includes one RS resource subgroup without BFR is used to determine the first RS resource subgroup.

In one embodiment, the first BFR information is the foremost BFR information of the at least one piece of BFR information.

In one embodiment, the foremost BFR information is a first piece of BFR information in the target MAC CE.

In one embodiment, the foremost BFR information is a piece of BFR information in the target MAC CE that is closest in distance to a MAC subheader of the target MAC CE.

In one embodiment, the foremost BFR information is a piece of BFR information in the target MAC CE immediately following the first bitmap.

In one embodiment, the foremost BFR information is a piece of BFR information in the target MAC CE that is closest in distance to the most significant bit of the target MAC CE.

In one embodiment, the foremost BFR information is a piece of BFR information in the target MAC CE that is furthest away from the most significant bit of the target MAC CE.

In one embodiment, the first signaling indicates a second RS resource set, the second RS resource set comprising at least one RS resource group, each of the at least one RS resource group being associated with one cell, and each of the at least one RS resource group comprising at least one RS resource subgroup, each RS resource subgroup comprising at least one RS resource: for each RS resource subgroup in the second RS resource set, whenever a radio link quality evaluated according to the each RS resource subgroup is worse than a first-type threshold, incrementing a first-class counter corresponding to the each RS resource subgroup by 1; determining whether to trigger a BFR according to whether the first-class counter corresponding to the each RS resource subgroup reaches a first-type value; there does not exist an RS resource subgroup with BFR in each RS resource group in the second RS resource set.

In one subembodiment, each RS resource subgroup in each RS resource group in the second RS resource set has no BFR when the target MAC CE is assembled.

In one subembodiment, each RS resource subgroup in each RS resource group in the second RS resource set has no BFR when the target MAC CE is generated.

In one subembodiment, each RS resource subgroup in each RS resource group in the second RS resource set has no BFR when a last BFR in all RS resource groups in the first RS resource set is triggered.

In one embodiment, one RS resource subgroup without BFR includes: the first-class counter associated with the RS resource subgroup has not reached the first-type value; or, a beam failure is not detected for the RS resource subgroup; or, a beam failure is detected for the RS resource subgroup, but an evaluation of candidate RS resources in the first-type candidate RS resource group being associated with the RS resource subgroup has not been completed.

In one embodiment, besides cells associated with the first RS resource set and cells associated with the second RS resource set, the first cell group comprises a SpCell, and, the first cell group also comprises 0 or at least 1 cell that is not activated yet, or the first cell group also comprises 0 or at least 1 cell that is not configured with a beam failure detection and recovery procedure.

In one embodiment, there exists in the first RS resource set and the second RS resource set at least one RS resource group in which the number of RS resource subgroups is equal to 2.

In one embodiment, a number of all RS resource groups in the first RS resource set and the second RS resource set is equal to a sum of a number of secondary cells and a number of SpCells.

In one embodiment, a number of all RS resource groups in the first RS resource set and the second RS resource set is equal to a number of secondary cells.

In one embodiment, a number of all RS resource groups in the first RS resource set and the second RS resource set is no greater than a number of secondary cells.

In one embodiment, a number of all RS resource groups in the first RS resource set and the second RS resource set is no greater than a sum of a number of secondary cells and a number of SpCells.

In one embodiment, a cell with which each RS resource group in the first RS resource set and the second RS resource set is associated is configured with a beam recovery procedure.

In one embodiment, a beam recovery procedure is performed on a cell with which each RS resource group in the first RS resource set and the second RS resource set is associated.

In one embodiment, a cell with which each RS resource group in the first RS resource set and the second RS resource set is associated is an active SCell.

In one embodiment, the second RS resource set includes at least one RS resource group.

In one embodiment, the second RS resource set is an empty set.

In one embodiment, the second RS resource set is not an empty set.

In one embodiment, the second RS resource set does not include any RS resource group.

In one embodiment, if an RS resource group includes two RS resource subgroups and each RS resource subgroup has a BFR, if the target MAC CE can contain BFR information for both of the two RS resource subgroups, the two pieces of BFR information in the target MAC CE that belong to the RS resource group are adjacent BFR information.

### Embodiment 2

Embodiment 2 illustrates a schematic diagram of a network architecture according to one embodiment of the present application, as shown in FIG. 2. FIG. 2 illustrates a network architecture 200 of 5G New Radio (NR)/Long-Term Evolution (LTE)/Long-Term Evolution Advanced (LTE-A) systems. The 5G NR/LTE/LTE-A network architecture 200 may be called a 5G System/Evolved Packet System (5GS/EPS) 200 or other suitable terminology. The 5GS/EPS 200 may comprise UE(s) 201, a RAN 202, a 5G Core Network/Evolved Packet Core (5GC/EPC) 210, a Home Subscriber Server/Unified Data Management(HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The RAN comprises a node 203 and another node 204. The node 203 provides UE 201 oriented user plane and control plane terminations. The node 203 can be connected to the other node 204 via an Xn interface (like backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 is a UE.

In one embodiment, the UE 201 is an ender.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB), or a gNB, or an eNB, or an ng-eNB, or an en-gNB, or a UE, or a relay, or a Gateway, or at least one TRP.

In one embodiment, the node 203 comprises at least one TRP.

In one embodiment, the node 203 is a logical node.

In one embodiment, different structures in the node 203 are located in the same entity.

In one embodiment, different structures in the node 203 are located in different entities.

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE supports NR.

In one embodiment, the UE supports UTRA.

In one embodiment, the UE supports EUTRA.

In one embodiment, the UE comprises a piece of equipment supporting transmissions with low delay and high reliability.

In one embodiment, the UE includes an aircraft, or a vehicle-mounted terminal, or a vessel, or an IoT terminal, or an IIoT terminal, or testing equipment, or a signaling test instrument.

In one embodiment, the base station supports transmissions in NTN.

In one embodiment, the base station supports transmissions in large-delay-difference networks.

In one embodiment, the base station supports transmissions in TN.

In one embodiment, the base station comprises a base station device supporting large time-delay difference.

In one embodiment, the base station comprises a Macro Cellular base station, or a Micro Cell base station, or a Pico Cell base station, or a Femtocell base station.

In one embodiment, the base station comprises a piece of flight platform equipment, or satellite equipment, or Transmitter Receiver Point (TRP), or a Centralized Unit (CU), or a Distributed Unit (DU), or test equipment, or signaling tester, or an Integrated Access and Backhaul (IAB)-node, or an IAB-donor, or an IAB-donor-CU, or an IAB-donor-DU, or an IAB-DU, or an IAB-MT.

In one embodiment, the relay includes a relay, or L3 relay, or L2 relay, or a Router, or an Exchanger.

### Embodiment 3

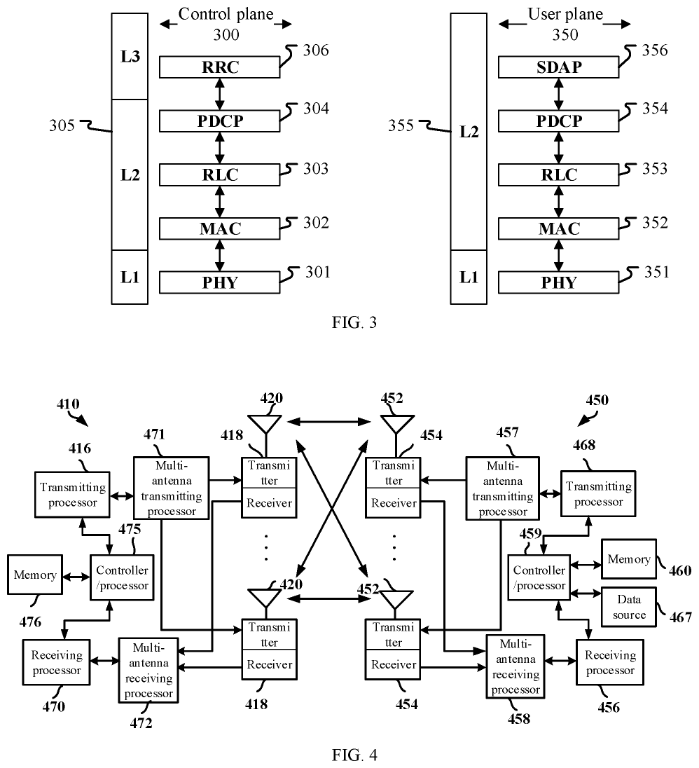

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, which are layer1, layer2 and layer3. The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC 306.

In one embodiment, the first signaling in the present application is generated by the MAC302 or the MAC352.

In one embodiment, the first signaling in the present application is generated by the PHY301 or the PHY351.

In one embodiment, the second signaling in the present application is generated by the RRC306.

In one embodiment, the second signaling in the present application is generated by the MAC302 or the MAC352.

In one embodiment, the second signaling in the present application is generated by the PHY301 or the PHY351.

In one embodiment, the target MAC CE in the present application is generated by the RRC306.

In one embodiment, the target MAC CE in the present application is generated by the MAC302 or the MAC352.

In one embodiment, the target MAC CE in the present application is generated by the PHY301 or the PHY351.

### Embodiment 4

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data. The memory 460 may be called a computer readable medium. In the transmission from the second communication device 410 to the second communication device 450, the controller/processor 459 provides demultiplexing between a transport channel and a logical channel, packet reassembling, decrypting. header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory, the at least one memory comprises computer program codes; the at least one memory and the computer program codes are configured to be used in collaboration with the at least one processor, the first communication device 450 at least receives a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; for each RS resource subgroup in the first RS resource set, whenever a radio link quality evaluated according to the each RS resource subgroup is worse than a first-type threshold, incrementing a first-class counter corresponding to the each RS resource subgroup by 1; determining whether to trigger a Beam Failure Recovery (BFR) according to whether the first-class counter corresponding to the each RS resource subgroup reaches a first-type value; and receives a second signaling, the second signaling indicating a first uplink grant; and transmits a target MAC CE according to the first uplink grant, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set; herein, there is at least one RS resource subgroup with BFR in each RS resource group in the first RS resource set; at least whether there is one RS resource subgroup without BFR included in the first RS resource group is used to determine the first RS resource subgroup.

In one embodiment, the first communication device 450 comprises a memory that stores a computer readable instruction program. The computer readable instruction program generates actions when executed by at least one processor. The actions include: receiving a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; for each RS resource subgroup in the first RS resource set, whenever a radio link quality evaluated according to the each RS resource subgroup is worse than a first-type threshold, incrementing a first-class counter corresponding to the each RS resource subgroup by 1; determining whether to trigger a Beam Failure Recovery (BFR) according to whether the first-class counter corresponding to the each RS resource subgroup reaches a first-type value; and receiving a second signaling, the second signaling indicating a first uplink grant; and transmitting a target MAC CE according to the first uplink grant, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set; herein, there is at least one RS resource subgroup with BFR in each RS resource group in the first RS resource set; at least whether there is one RS resource subgroup without BFR included in the first RS resource group is used to determine the first RS resource subgroup.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; and transmits a second signaling, the second signaling indicating a first uplink grant; and receives a target MAC CE, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set; herein, for each RS resource subgroup in the first RS resource set, whenever a radio link quality evaluated according to the each RS resource subgroup is worse than a first-type threshold, a first-class counter corresponding to the each RS resource subgroup is incremented by 1; it is determined whether a BFR is to be triggered according to whether the first-class counter corresponding to the each RS resource subgroup reaches a first-type value; the target MAC CE is transmitted according to the first uplink grant; there is at least one RS resource subgroup with BFR in each RS resource group in the first RS resource set; at least whether there is one RS resource subgroup without BFR included in the first RS resource group is used to determine the first RS resource subgroup.

In one embodiment, the second communication device 410 comprises a memory that stores a computer readable instruction program. The computer readable instruction program generates actions when executed by at least one processor. The actions include: transmitting a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; and transmitting a second signaling, the second signaling indicating a first uplink grant; and receiving a target MAC CE, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set; herein, for each RS resource subgroup in the first RS resource set, whenever a radio link quality evaluated according to the each RS resource subgroup is worse than a first-type threshold, a first-class counter corresponding to the each RS resource subgroup is incremented by 1; it is determined whether a BFR is to be triggered according to whether the first-class counter corresponding to the each RS resource subgroup reaches a first-type value; the target MAC CE is transmitted according to the first uplink grant; there is at least one RS resource subgroup with BFR in each RS resource group in the first RS resource set; at least whether there is one RS resource subgroup without BFR included in the first RS resource group is used to determine the first RS resource subgroup.

In one embodiment, the antenna 452, the receiver 454, the receiving processor 456 and the controller/processor 459 are used for receiving a first signaling; at least one of the antenna 420, the transmitter 418, the transmitting processor 416 or the controller/processor 475 is used for transmitting a first signaling.

In one embodiment, the antenna 452, the receiver 454, the receiving processor 456, and the controller/processor 459 are used for receiving a second signaling; at least one of the antenna 420, the transmitter 418, the transmitting processor 416 or the controller/processor 475 is used for transmitting a second signaling.

In one embodiment, the antenna 452, the transmitter 454, the transmitting processor 468 and the controller/processor 459 are used for transmitting a target MAC CE; at least one of the antenna 420, the receiver 418, the receiving processor 470 or the controller/processor 475 is used for receiving a target MAC CE.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a UE supporting large delay difference.

In one embodiment, the first communication device 450 is a UE supporting NTN.

In one embodiment, the first communication device 450 is an aircraft.

In one embodiment, the first communication device 450 is capable of positioning.

In one embodiment, the first communication device 450 is incapable of positioning.

In one embodiment, the first communication device 450 is a UE supporting TN.

In one embodiment, the second communication device 410 is a base station (gNB/eNB/ng-eNB).

In one embodiment, the second communication device 410 is a UE.

In one embodiment, the second communication device 410 is a base station supporting large delay difference.

In one embodiment, the second communication device 410 is a base station supporting NTN.

In one embodiment, the second communication device 410 is satellite equipment.

In one embodiment, the second communication device 410 is a flight platform.

In one embodiment, the second communication device 410 is a base station supporting TN.

### Embodiment 5

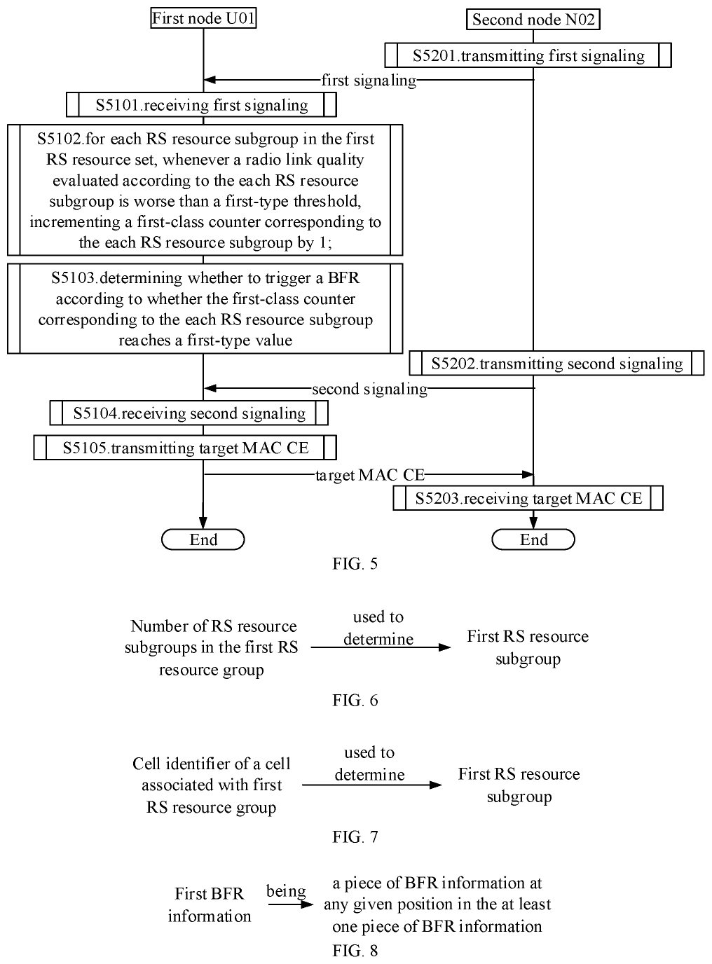

Embodiment 5 illustrates a flowchart of radio signal transmission according to one embodiment of the present application, as shown in FIG. 5. It should be particularly noted that the sequence illustrated herein does not set any limit to the signal transmission order or implementation order in the present application.

The first node U01 receives a first signaling in step S5101, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; in step S5102, for each RS resource subgroup in the first RS resource set, whenever a radio link quality evaluated according to the each RS resource subgroup is worse than a first-type threshold, increments a first-class counter corresponding to the each RS resource subgroup by 1; in step S5103, determines whether to trigger a Beam Failure Recovery (BFR) according to whether the first-class counter corresponding to the each RS resource subgroup reaches a first-type value; and in step S5104, receives a second signaling, the second signaling indicating a first uplink grant; and in step S5105, transmits a target MAC CE according to the first uplink grant, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set.

The second node N02 transmits the first signaling in step S5201; and transmits the second signaling in step S5202; and receives the target MAC CE in step S5203.

In Embodiment 5, there is at least one RS resource subgroup with BFR in each RS resource group in the first RS resource set; at least whether there is one RS resource subgroup without BFR included in the first RS resource group is used to determine the first RS resource subgroup.

In one embodiment, the first node U01 comprises a UE.

In one embodiment, the first node U01 comprises a detection device.

In one embodiment, the first node U01 comprises a testing device.

In one embodiment, the second node N02 comprises at least a base station.

In one embodiment, the second node N02 is a maintenance base station for any cell in the first cell group.

In one embodiment, the second node N02 comprises at least a TRP.

In one embodiment, the second node N02 comprises a maintenance base station for at least a serving cell.

In one embodiment, the second node N02 comprises at least a relay device.

In one embodiment, the second node N02 comprises at least a UE.

In one embodiment, the second node N02 is a maintenance base station for the first node U01.

In one embodiment, the second node N02 is at least one TRP in a maintenance base station for the first node U01.

In one embodiment, the second node N02 is a maintenance base station for a SpCell of the first node U01.

In one embodiment, the step S5102 and the step S5103 are performed for each RS resource subgroup in the first RS resource set.

In one embodiment, the step S5102 and the step S5103 are performed for each RS resource subgroup in the second RS resource set.

In one embodiment, the step S5102 and the step S5103 are performed for an RS resource subgroup in the SpCell.

### Embodiment 6

Embodiment 6 illustrates a schematic diagram of a number of RS resource subgroups in the first RS resource group being used to determine a first RS resource subgroup according to the present application, as shown in FIG. 6.

In Embodiment 6, a number of RS resource subgroups in the first RS resource group is used to determine the first RS resource subgroup.

In one embodiment, the phrase that “a number of RS resource subgroups in the first RS resource group is used to determine the first RS resource subgroup” includes: the number of RS resource subgroups included in the first RS resource group and the number of RS resource subgroups included in the second RS resource group are used to determine the first RS resource subgroup.

In one embodiment, the phrase that “a number of RS resource subgroups in the first RS resource group is used to determine the first RS resource subgroup” includes: determining the first RS resource subgroup according to the number of RS resource subgroups included in the first RS resource group.

In one subembodiment, the first RS resource subgroup is an RS resource group having the highest number of RS resource subgroups in the first RS resource set.

In one subembodiment, the first RS resource subgroup is an RS resource group having the lowest number of RS resource subgroups in the first RS resource set.

In one embodiment, the phrase that “a number of RS resource subgroups in the first RS resource group is used to determine the first RS resource subgroup” includes: the number of RS resource subgroups included in the first RS resource group being equal to a first target value is used to determine the first RS resource subgroup.

In one subembodiment, the first RS resource subgroup is an RS resource group in which the number of RS resource subgroup(s) included in the first RS resource group is equal to 1.

In one subembodiment, the first RS resource subgroup is an RS resource group in which the number of RS resource subgroup(s) included in the first RS resource group is equal to 2.

In one subembodiment, the first target value is a maximum value of the number of RS resource subgroups included in an RS resource group.

In one embodiment, whether the first RS resource group includes an RS resource subgroup without BFR and the number of RS resource subgroups included in the first RS resource group are used to determine the first RS resource subgroup.

In one embodiment, the first RS resource group is an RS resource group in the first RS resource set which includes one RS resource subgroup without BFR and in which the number of RS resource subgroups included is equal to a given value, and the first RS resource subgroup is an RS resource subgroup in the first RS resource group.

In one embodiment, the first RS resource group is an RS resource group in the first RS resource set which does not include an RS resource subgroup without BFR and in which the number of RS resource subgroups included is equal to a given value, and the first RS resource subgroup is an RS resource subgroup in the first RS resource group.

In one embodiment, the given value is one of 1 or 2 or 3 or 4 or 5 or 6 or 7 or 8.

### Embodiment 7

Embodiment 7 illustrates a schematic diagram of a cell identifier of a cell associated with a first RS resource group being used to determine a first RS resource subgroup according to one embodiment of the present application, as shown in FIG. 7.

In Embodiment 7, a cell identifier of a cell associated with the first RS resource group is used to determine the first RS resource subgroup.

In one embodiment, the phrase that “a cell identifier of a cell associated with the first RS resource group is used to determine the first RS resource subgroup” includes: determining the first RS resource subgroup based on the cell identifier of the cell associated with the first RS resource group.

In one subembodiment, the first RS resource subgroup is an RS resource subgroup in one RS resource group that is associated with a cell with a smallest cell identifier in the first RS resource set.

In one subembodiment, the first RS resource subgroup is an RS resource subgroup in one RS resource group that is associated with a cell with a largest cell identifier in the first RS resource set.

In one embodiment, the phrase that “a cell identifier of a cell associated with the first RS resource group is used to determine the first RS resource subgroup” includes: the cell identifier of the cell associated with the first RS resource group being equal to a second target value is used to determine the first RS resource subgroup.

In one subembodiment, the second target value is the smallest value of all cell identifiers of all cells associated with all RS resource groups in the first RS resource set.

In one subembodiment, the second target value is the second smallest value of all cell identifiers of all cells associated with all RS resource groups in the first RS resource set.

In one subembodiment, the second target value is the second smallest value of all cell identifiers of all cells associated with all RS resource groups in the first RS resource set.

In one subembodiment, the second target value is the largest value of all cell identifiers of all cells associated with all RS resource groups in the first RS resource set.

In one subembodiment, the second target value is the second largest value of all cell identifiers of all cells associated with all RS resource groups in the first RS resource set.

In one embodiment, the first RS resource group is an RS resource group in the first RS resource set which includes an RS resource subgroup without BFR and in which the number of RS resource subgroups included is equal to a given value and which is associated with a cell with a smallest cell identifier, and the first RS resource subgroup is an RS resource subgroup in the first RS resource group.

In one embodiment, the first RS resource group is an RS resource group in the first RS resource set which does not include an RS resource subgroup without BFR and in which the number of RS resource subgroups included is equal to a given value and which is associated with a cell with a smallest cell identifier, and the first RS resource subgroup is an RS resource subgroup in the first RS resource group.

In one embodiment, the given value is one of 1 or 2 or 3 or 4 or 5 or 6 or 7 or 8.

In one embodiment, the cell identifier includes a ServCellIndex of the cell.

In one embodiment, the cell identifier includes a SCellIndex of the cell.

In one embodiment, the cell identifier is configured by a ServCellIndex.

In one embodiment, the cell identifier is a non-negative integer.

### Embodiment 8

Embodiment 8 illustrates a schematic diagram of first BFR information being a piece of BFR information at any given position in the at least one piece of BFR information according to one embodiment of the present application, as shown in FIG. 8.

In Embodiment 8, the first BFR information is a piece of BFR information at any given position in the at least one piece of BFR information.

In one embodiment, the phrase that “the first BFR information is a piece of BFR information at any given position in the at least one piece of BFR information” includes: the first BFR information is located at any given position among the at least one piece of BFR information in the target MAC CE.

In one embodiment, the phrase that “the first BFR information is a piece of BFR information at any given position in the at least one piece of BFR information” includes: the first BFR information is a piece of BFR information of the at least one piece of BFR information which is at a given position in the target MAC CE.

In one embodiment, the phrase that “the first BFR information is a piece of BFR information at any given position in the at least one piece of BFR information” includes: the first BFR information is a first piece of BFR information among the at least one piece of BFR information in the target MAC CE.

In one embodiment, the phrase that “the first BFR information is a piece of BFR information at any given position in the at least one piece of BFR information” includes: the first BFR information is a u-th piece of BFR information among the at least one piece of BFR information in the target MAC CE, where u is not less than 1 and not greater than the stated min{Q1, Q}.

In one embodiment, the phrase that “the first BFR information is a piece of BFR information at any given position in the at least one piece of BFR information” includes: the first BFR information is a last piece of BFR information among the at least one piece of BFR information in the target MAC CE.

### Embodiment 9

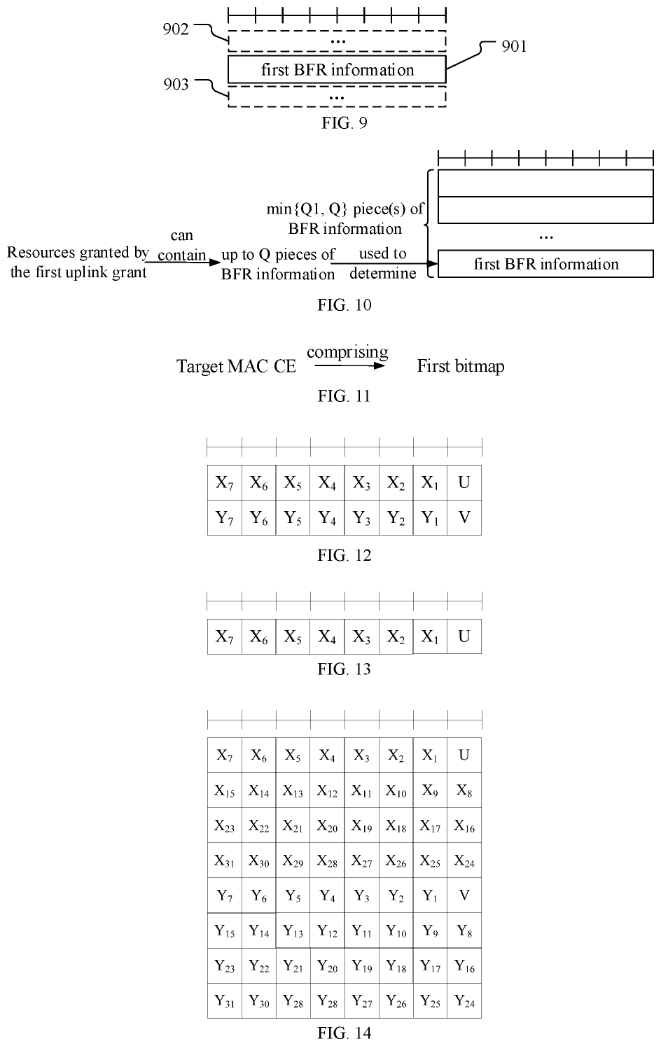

Embodiment 9 illustrates a schematic diagram of a location of first BFR information according to one embodiment of the present application, as shown in FIG. 9. The FIG. 9 is a schematic diagram of a MAC CE, with the box 901 corresponding to the first BFR information, and the dashed-line boxes 901 and 902 denoting other BFR information in the at least one piece of BFR information in the target MAC CE.

In one embodiment, at least one of the dashed-line box 901 or the dashed-line box 902 does not exist.

In one embodiment, neither of the dashed-line box 901 and the dashed-line box 902 exists.

In one embodiment, both of the dashed-line box 901 and the dashed-line box 902 exist.

In one embodiment, the dashed-line box 901 includes at least one piece of BFR information when the box 901 is present.

In one embodiment, the dashed-line box 902 includes at least one piece of BFR information when the box 902 is present.

In one embodiment, each piece of BFR information is byte-aligned in the target MAC CE.

In one embodiment, the length of each box is equal to one byte, the one byte comprising 8 bits.

In one embodiment, if the given RS resource group includes one RS resource subgroup without BFR and the first RS resource group does not include an RS resource subgroup without BFR, the BFR information associated with RS resource subgroups in the given RS resource group is located before the BFR information of RS resource subgroups in the first RS resource group.

In one embodiment, if the given RS resource group does not include one RS resource subgroup without BFR and the first RS resource group includes an RS resource subgroup without BFR, the BFR information associated with RS resource subgroups in the given RS resource group is located before the BFR information of RS resource subgroups in the first RS resource group.

In one embodiment, if the number of RS resource subgroups included in the given RS resource group is equal to 1, and if the number of RS resource subgroups included in the first RS resource group is equal to 2, the BFR information associated with RS resource subgroups in the given RS resource group is located before the BFR information of RS resource subgroups in the first RS resource group.

In one embodiment, if the number of RS resource subgroups included in the given RS resource group is equal to 2, and if the number of RS resource subgroups included in the first RS resource group is equal to 1, the BFR information associated with RS resource subgroups in the given RS resource group is located before the BFR information of RS resource subgroups in the first RS resource group.

In one embodiment, if the cell identifier of a cell associated with the given RS resource group is greater than the cell identifier of a cell associated with the first RS resource group, the BFR information associated with RS resource subgroups in the given RS resource group is located before the BFR information of RS resource subgroups in the first RS resource group.

In one embodiment, if the cell identifier of a cell associated with the given RS resource group is less than the cell identifier of a cell associated with the first RS resource group, the BFR information associated with RS resource subgroups in the given RS resource group is located before the BFR information of RS resource subgroups in the first RS resource group.

### Embodiment 10

Embodiment 10 illustrates a schematic diagram of first BFR information being a last piece of BFR information in the at least one piece of BFR information according to one embodiment of the present application, as shown in FIG. 10.

In Embodiment 10, the first BFR information is a last piece of BFR information in the at least one piece of BFR information; resources granted by the first uplink grant can contain up to Q pieces of BFR information, Q being a positive integer, Q being used to determine the first RS resource subgroup.

In one embodiment, the number of RS resource subgroups with BFRs in the first RS resource set is equal to Q1, and the number of the at least one piece of BFR information is not greater than Q1, Q1 being a positive integer.

In one embodiment, Q1 in this application is no greater than a product of P1 and 2.

In one embodiment, Q1 in this application is no greater than a product of P1 and 3.

In one embodiment, Q1 in this application is no greater than a product of P1 and 4.

In one embodiment, the number of pieces of BFR information in the target MAC CE is equal to min{Q1, Q}, the min{Q1, Q} being the smallest value of Q and Q1.

In one embodiment, the at least one piece of BFR information included in the target MAC CE includes/include min{Q1, Q} piece(s) of BFR information.

In one embodiment, if Q is not less than Q1, the first BFR information is a last piece of BFR information among the Q1 pieces of BFR information: where the last piece of BFR information among the at least one piece of BFR information is the last piece of BFR information among the Q1 pieces of BFR information.

In one subembodiment, the last piece of BFR information of the Q1 pieces of BFR information is the Q1-st BFR information of the Q1 pieces of BFR information.

In one embodiment, if Q is less than Q1, the first BFR information is the Q1-st piece of BFR information among the Q1 pieces of BFR information; where the last piece of BFR information among the at least one piece of BFR information is the Q-th piece of BFR information among the Q1 pieces of BFR information.

In one embodiment, if Q is not less than 1 and Q1 is equal to 1, the first BFR information is the only one piece of BFR information of the Q1 piece(s) of BFR information; if Q is not less than 2 and Q1 is equal to 2, the first BFR information is the 2nd BFR information of the Q1 pieces of BFR information; . . . and so on.

In one embodiment, if Q is equal to 1 and Q1 is no less than 2, the first BFR information is the 1st BFR information of the Q1 pieces of BFR information; if Q is equal to 2 and Q1 is no less than 3, the first BFR information is the 2nd BFR information of the Q1 pieces of BFR information; . . . and so on.

In one embodiment, the phrase “Q being used to determine the first RS resource subgroup” comprises that: the first RS resource subgroup is related to Q.

In one embodiment, the phrase “Q being used to determine the first RS resource subgroup” comprises that: the first BFR information being associated with the first RS resource subgroup is a Q-th piece of BFR information.

In one embodiment, the number of pieces of BFR information contained in the target MAC CE is determined based on the size of resources granted by the first uplink grant.

In one embodiment, the first BFR information is related to the size of the resources granted by the first uplink grant.

In one embodiment, resources granted by the first uplink grant are used to transmit at least the target MAC CE and a MAC subheader with a LCID field set to a first integer.

In one embodiment, resources granted by the first uplink grant are used to transmit at least the target MAC CE, a MAC subheader corresponding to the target MAC CE, a C-RNTI MAC CE with a C-RNTI field set to a C-RNTI of the first node in the first cell group, and a MAC subheader corresponding to the C-RNTI MAC CE.

In one embodiment, a LCID field in a corresponding MAC subheader of the target MAC CE is set to one of 50, or 51, or an integer not less than 35 and not greater than 44, or 47, or 63.

In one embodiment, an eLCID field in a corresponding MAC subheader of the target MAC CE is set to 250, or 251, or an integer not less than 0 and not greater than 249.

In one embodiment, resources granted by the first uplink grant include at least one of a time-domain resource or a frequency-domain resource or a code-domain resource or a spatial-domain resource.

In one embodiment, the phrase that “the first BFR information is a last piece of BFR information in the at least one piece of BFR information” includes: a last byte in the target MAC CE is the first BFR information.

In one embodiment, the phrase that “the first BFR information is a last piece of BFR information in the at least one piece of BFR information” includes: the last BFR information in the target MAC CE in order from high to low is the first BFR information.

In one embodiment, the phrase that “the first BFR information is a last piece of BFR information in the at least one piece of BFR information” includes: the last BFR information in the at least one piece of BFR information sorted in the first order is the first BFR information.

In one embodiment, the phrase that “resources granted by the first uplink grant can contain up to Q pieces of BFR information” includes: the size of resource capable of being used to carry BFR information in the resources granted by the first uplink grant does not exceed the product of Q and the size of one piece of BFR information.

### Embodiment 11

Embodiment 11 illustrates a schematic diagram of a target MAC CE comprising a first bitmap according to one embodiment of the present application, as shown in FIG. 11.

In Embodiment 11, the target MAC CE comprises a first bitmap, a first bit in the first bitmap indicates the first RS resource subgroup or the first bit in the first bitmap indicates a cell associated with the first RS resource group.

In one embodiment, the size of the first bitmap is related to a maximum value of a cell identifier of a cell to which RS resource subgroups with BFR in the first RS resource set belong.

In one embodiment, if a maximum value of a cell identifier of a cell to which RS resource subgroups with BFR in the first RS resource set belong is not greater than 7, the first bitmap comprises 8 bits.

In one embodiment, if a maximum value of a cell identifier of a cell to which RS resource subgroups with BFR in the first RS resource set belong is not greater than 7, the first bitmap comprises 16 bits.

In one embodiment, if a maximum value of a cell identifier of a cell to which RS resource subgroups with BFR in the first RS resource set belong is greater than 7, the first bitmap comprises 32 bits.

In one embodiment, if a maximum value of a cell identifier of a cell to which RS resource subgroups with BFR in the first RS resource set belong is greater than 7, the first bitmap comprises 64 bits.

In one embodiment, if a maximum value of a cell identifier of a cell to which RS resource subgroups with BFR in the first RS resource set belong is greater than 7, the first bitmap comprises no fewer than 32 bits and no more than 64 bits.

In one embodiment, the first bitmap is a bitmap.

In one embodiment, the first bitmap comprises 8 bits.

In one embodiment, the first bitmap comprises 16 bits.

In one embodiment, the first bitmap comprises 32 bits.

In one embodiment, the first bitmap comprises 64 bits.

In one embodiment, the first bitmap comprises 40 bits or 48 bits or 56 bits or 64 bits.

In one embodiment, the length of the first bitmap is of a fixed size.

In one embodiment, the length of the first bitmap is variable.

In one embodiment, the first bitmap comprises a first specific field, the first specific field indicating the SpCell.

In one embodiment, the first specific field is located in the least significant bit in the first bitmap.

In one embodiment, the first specific field is located in the 8th most significant bit from high to low in the first bitmap.

In one embodiment, the first specific field is located in the rightmost bit of a first octet in the first bitmap.

In one embodiment, the first specific field is located in the 1st bit in the first bitmap.

In one embodiment, the length of the first specific field is equal to 1 bit.

In one embodiment, the length of the first specific field is equal to 2 bits.

In one embodiment, the first bit is any bit in the first bitmap.

In one embodiment, the first bit is a bit in the first bitmap other than the first specific field.

In one embodiment, a position of the first bit in the first bitmap is related to a cell identifier of a cell associated with the first RS resource group.

In one subembodiment, if the cell identifier of the cell associated with the first RS resource group is equal to 1, the first bit is a 2nd bit in the first bitmap; if the cell identifier of the cell associated with the first RS resource group is equal to 2, the first bit is a 3rd bit in the first bitmap . . . and so on.

In one subembodiment, the bits in the first bitmap are sorted in ascending order according to the cell identifiers of the cells.

In one subembodiment, a position of the first bit in the first bitmap is determined according to the cell identifier of the cell associated with the first RS resource group.

In one embodiment, a first bit in the first bitmap indicates the first RS resource subgroup.

In one embodiment, a first bit in the first bitmap corresponds to the first RS resource subgroup.

In one embodiment, a first bit in the first bitmap indicates whether the first RS resource subgroup has a BFR.

In one embodiment, that a first bit in the first bitmap is set to 1 indicates that the first RS resource subgroup has a BFR.

In one embodiment, that a first bit in the first bitmap is set to 0 indicates that the first RS resource subgroup has no BFR.

In one embodiment, a first bit in the first bitmap indicates a cell associated with the first RS resource group.

In one embodiment, a first bit in the first bitmap corresponds to a cell associated with the first RS resource group.

In one embodiment, a first bit in the first bitmap indicates whether BFR is available in a cell associated with the first RS resource group.

In one embodiment, that a first bit in the first bitmap is set to 1 indicates that BFR is available in a cell associated with the first RS resource group.

In one embodiment, that a first bit in the first bitmap is set to 0 indicates that BFR is unavailable in a cell associated with the first RS resource group.

In one embodiment, the first bitmap comprises a first sub-bitmap and a second sub-bitmap, the first sub-bitmap comprising a first bit, the second sub-bitmap comprising a second bit.

In one subembodiment, the first sub-bitmap and the second sub-bitmap are of equal size.

In one subembodiment, the first sub-bitmap and the second sub-bitmap are of unequal sizes.

In one subembodiment, the second bitmap comprises a second specific field, the second specific field indicating the SpCell.

In one subembodiment, the second specific field is located in the least significant bit in the second sub-bitmap.

In one subembodiment, the second specific field is located in the 1st bit in the second sub-bitmap.

In one subembodiment, the length of the second specific field is equal to 1 bit.

In one subembodiment, the length of the second specific field is equal to 2 bits.

In one subembodiment, the first bit in the first sub-bitmap indicates the first RS resource group, while the second bit in the second sub-bitmap is reserved; where the first RS resource group comprises one RS resource subgroup.

In one subsidiary embodiment of the above subembodiment, the first bit is set to 1 if the first RS resource group has a BFR, otherwise, the first bit is set to 0.

In one subembodiment, the first bit in the first sub-bitmap indicates the first RS resource subgroup, while the second bit in the second sub-bitmap indicates a second RS resource subgroup, the second RS resource subgroup being an RS resource subgroup other than the first RS resource subgroup in the first RS resource group: the first RS resource group comprises two RS resource subgroups.

In one subsidiary embodiment of the above subembodiment, the first bit is set to 1 if the first RS resource subgroup in the first RS resource group has a BFR, otherwise, the first bit is set to 0; the second bit is set to 1 if the second RS resource subgroup in the first RS resource group has a BFR, otherwise, the second bit is set to 0.

In one subembodiment, the first bit in the first sub-bitmap indicates the cell associated with the first RS resource group, while the second bit in the second sub-bitmap indicates whether there is one RS resource subgroup without BFR included in the first RS resource group; the first RS resource group comprises two RS resource subgroups.

In one subsidiary embodiment of the above subembodiment, the first bit is set to 1 if at least one RS resource subgroup in the first RS resource group has a BFR, otherwise, the first bit is set to 0; the second bit is set to 1 if each RS resource subgroup in the first RS resource group has a BFR, otherwise, the second bit is set to 0.

In one subembodiment, the first bit in the first sub-bitmap indicates the cell associated with the first RS resource group, while the second sub-bitmap is reserved; the first RS resource group comprises one RS resource subgroup.

In one subsidiary embodiment of the above subembodiment, the first bit is set to 1 if the first RS resource group has a BFR, otherwise, the first bit is set to 0; the second bit is reserved.

In one embodiment, the second sub-bitmap is closely behind the first sub-bitmap.

In one embodiment, the second sub-bitmap is located in a last byte in the target MAC CE.

In one embodiment, the second sub-bitmap is located in a designated byte in the target MAC CE.

In one embodiment, the identity of the cell includes an identity of a serving cell.

In one embodiment, the identity of the cell includes an identity of a SCell.

In one embodiment, the identity of the cell is indicated by a ServCellIndex.

### Embodiment 12

Embodiment 12 illustrates a schematic diagram of a first bitmap according to one embodiment of the present application, as shown in FIG. 12. In FIG. 12, each line represents a byte, and each byte includes 8 bits.

In Embodiment 12, the first bitmap comprises a first sub-bitmap and a second sub-bitmap, the first sub-bitmap comprising one byte, the second sub-bitmap comprising one byte.

In one embodiment, the first bit is one of the X₁, . . . , the X₇, the second bit is one of the Y₁, . . . , the Y₇, the first bit and the second bit having the same equal subscripts.

In one embodiment, the first bit corresponds to Xᵢ, and the second bit corresponds to Yᵢ, where i=1, 2, . . . , 7.

In one embodiment, the X₁, . . . , the X₇ are C₁, . . . , C₇, respectively.

In one embodiment, the Y₁, . . . , the Y₇ are C₁, . . . , C₇, respectively.

In one embodiment, the X₁, . . . , the X₇ are T₁, . . . , T₇, respectively.

In one embodiment, the Y₁, . . . , the Y₇ are T₁, . . . , T₇, respectively.

In one embodiment, the first specific field is the U field, and the second specific field is the V field.

In one embodiment, the U field is an SP field.

In one embodiment, the V field is an SP field.

### Embodiment 13

Embodiment 13 illustrates a schematic diagram of a first bitmap according to another embodiment of the present application, as shown in FIG. 13.

In one embodiment, the first bitmap comprises one byte.

In one embodiment, the first bit is one of the X₁, . . . , the X₇.

In one embodiment, the X₁, . . . , the X₇ are C₁, . . . , C₇, respectively.

In one embodiment, the X₁, . . . , the X₇ are T₁, . . . , T₇, respectively.

In one embodiment, the first specific field is the U field.

In one embodiment, the U field is an SP field.

### Embodiment 14

Embodiment 14 illustrates a schematic diagram of a first bitmap according to a third embodiment of the present application, as shown in FIG. 14.

In Embodiment 14, the first bitmap comprises a first sub-bitmap and a second sub-bitmap, the first sub-bitmap comprising 4 bytes, the second sub-bitmap comprising 4 bytes.

In one embodiment, the first bit is one of the X₁, . . . , the X₃₁, the second bit is one of the Y₁, . . . , the Y₃₁, the first bit and the second bit having the same equal subscripts.

In one embodiment, the first bit corresponds to Xᵢ, and the second bit corresponds to Yᵢ, where i=1, 2, . . . , 31.

In one embodiment, the X₁, . . . , the X₃₁ are C₁, . . . , C₃₁, respectively.

In one embodiment, the Y₁, . . . , the Y₃₁ are C₁, . . . , C₃₁, respectively.

In one embodiment, the X₁, . . . , the X₃₁ are T₁, . . . , T₃₁, respectively.

In one embodiment, the Y₁, . . . , the Y₃₁ are T₁, . . . , T₃₁, respectively.

In one embodiment, the first specific field is the U field, and the second specific field is the V field.

In one embodiment, the U field is an SP field.

In one embodiment, the V field is an SP field.

### Embodiment 15

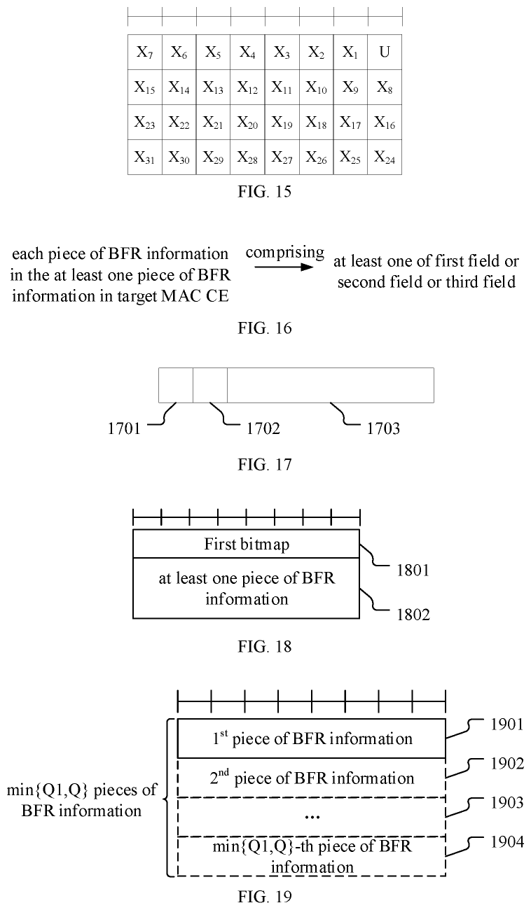

Embodiment 15 illustrates a schematic diagram of a first bitmap according to a fourth embodiment of the present application, as shown in FIG. 15.

In one embodiment, the first bitmap comprises 4 bytes.

In one embodiment, the first bit is one of the X₁, . . . , the X₃₁.

In one embodiment, the X₁, . . . , the X₃₁ are C₁, . . . , C₃₁, respectively.

In one embodiment, the X₁, . . . , the X₃₁ are T₁, . . . , T₃₁, respectively.

In one embodiment, the first specific field is the U field.

In one embodiment, the U field is an SP field.

### Embodiment 16

Embodiment 16 illustrates a schematic diagram of each piece of BFR information in the at least one piece of BFR information in a target MAC CE comprising at least one of a first field or a second field or a third field according to one embodiment of the present application, as shown in FIG. 16.

In Embodiment 16, the first BFR information comprises at least one of a first field, a second field or a third field: the first field in the first BFR information is used to indicate whether the second field in the first BFR information exists, if the first field in the first BFR information indicates that the second field in the first BFR information exists, the second field in the first BFR information indicates a first RS resource, the first RS resource being associated with the first RS resource subgroup; if the first field in the first BFR information indicates that the second field in the first BFR information does not exist, the second field in the first BFR information is reserved; the third field in the first BFR information is reserved or the third field in the first BFR information is used to indicate the first RS resource subgroup.

In one embodiment, the first BFR information includes at least a first field.

In one embodiment, the first BFR information includes at least the first field and the second field.

In one embodiment, the first BFR information includes at least the first field, the second field and the third field.

In one embodiment, the first field in the first BFR information is set to 1.

In one embodiment, the first field in the first BFR information is set to 0.

In one embodiment, the first field in the first BFR information is an AC field.

In one embodiment, the first field in the first BFR information is used to indicate whether there exists the second field in the first BFR information; that the first field in the first BFR information is set to 1 indicates that the second field exists in the first BFR information, and that the first field in the first BFR information is set to 0 indicates that the second field does not exist in the first BFR information.

In one embodiment, the above phrase “the second field exists” means that: the second field is not reserved.

In one embodiment, the above phrase “the second field exists” means that: the second field is used to indicate a candidate reference signal.

In one embodiment, the above phrase “the second field does not exist” means that: the second field is reserved.

In one embodiment, the above phrase “the second field does not exist” means that: a bit corresponding to the second field is set to any value.

In one embodiment, the above phrase “the second field does not exist” means that: bits corresponding to the second field are R bits.

In one embodiment, the above phrase “the second field does not exist” means that: the second field is not used to indicate a candidate reference signal.

In one embodiment, the first field in the first BFR information is used to indicate whether there exists the second field in the first BFR information: that the first field is set to 1 indicates that the second field exists, and that the first field is set to 0 indicates that the second field does not exist.

In one embodiment, setting the first field to 1 if there is at least one reference signal resource in a first candidate RS resource set with available measurement result(s) higher than a predetermined threshold; otherwise, setting the first field to 0; where the first RS resource is an RS resource among the at least one reference signal resource with available measurement result(s) higher than the predetermined threshold.

In one embodiment, the measurement result includes one of SS-RSRP or CSI-RSRP.

In one embodiment, the phrase higher than refers to: above.

In one embodiment, the phrase higher than refers to: greater than.

In one embodiment, the phrase higher than refers to: not less than.

In one embodiment, the phrase “the first RS resource being associated with the first RS resource subgroup” includes: the first RS resource being configured for the first RS resource subgroup.

In one embodiment, the phrase “the first RS resource being associated with the first RS resource subgroup” includes: the first RS resource being used for BFR information associated with the first RS resource subgroup.

In one embodiment, the first RS resource is only associated with the first RS resource subgroup.

In one embodiment, the first RS resource is associated with the first RS resource subgroup and the first RS resource is not associated with other RS resource subgroups.

In one embodiment, the first RS resource is associated with the first RS resource subgroup and the first RS resource is not associated with another RS resource subgroup in the first RS resource group.

In one embodiment, the first RS resource is associated with the first RS resource subgroup and the first RS resource is associated with an RS resource subgroup in an RS resource group other than the first RS resource group.

In one embodiment, any RS resource in the first candidate RS resource set is associated with the first RS resource subgroup.

In one embodiment, the phrase that “the second field in the first BFR information indicates a first RS resource” includes: the second field in the first BFR information is set to an index of the first RS resource.

In one embodiment, the first RS resource is a reference signal resource with a measurement result above a predetermined threshold in the first candidate RS resource set.

In one embodiment, the first RS resource is a reference signal resource with an available measurement result above a predetermined threshold in the first candidate RS resource set

In one embodiment, the length of the second field is 6 bits.

In one embodiment, the length of the second field is 5 bits.

In one embodiment, the length of the second field is 4 bits.

In one embodiment, an index of the first RS resource is an index of an entry corresponding to the first RS resource in the above IE configuration of the above RRC message.

In one embodiment, the length of the third field is 1 bit.

In one embodiment, the length of the third field is 2 bits.

In one embodiment, the length of the third field is 3 bits.

In one embodiment, the third field in the first BFR information is reserved.

In one subembodiment, the third field in the first BFR information is R field.

In one subembodiment, the third field in the first BFR information comprises reserved bits, the third field being set to 0.

In one embodiment, the third field in the first BFR information is used to indicate the first RS resource subgroup.

In one subembodiment, the third field in the first BFR information indicates an index of the first RS resource subgroup.

In one subembodiment, the third field in the first BFR information explicitly indicates the first RS resource subgroup.

In one subembodiment, the third field in the first BFR information implicitly indicates the first RS resource subgroup.

In one subembodiment, an index of the first RS resource subgroup is 0 or 1.

In one subembodiment, an index of the first RS resource subgroup is one of 1 or 2 or 3 or 4.

In one subembodiment, the third field in the first BFR information is set to 0 or 1.

In one embodiment, the third field comprises a first sub-field and a second sub-field, the first sub-field comprising 1 bit, the second sub-field comprising 1 bit.

In one subembodiment, the first sub-field in the third field is used to indicate the first RS resource subgroup, and the second sub-field in the third field is used to indicate whether the first RS resource group also includes another RS resource subgroup with BFR.

In one subembodiment, the first RS resource group consists of the first RS resource subgroup and the second RS resource subgroup; the other RS resource subgroup with BFR being the second RS resource subgroup.

In one subembodiment, that the second sub-field in the third field is set to 1 indicates that the first RS resource group also includes another RS resource subgroup with BFR and the BFR information being not indicated; that the second sub-field in the third field is set to 0 indicates that the first RS resource group does not include another RS resource subgroup with BFR and the BFR information being not indicated.

In one subembodiment, if the second sub-field in the third field indicates that the first RS resource group also includes another RS resource subgroup with BFR and the BFR information being not indicated, a piece of BFR information immediately following the first BFR information is the BFR information that is associated with the other RS resource subgroup with BFR in the first RS resource group; if the second sub-field in the third field indicates that the first RS resource group does not include another RS resource subgroup with BFR and the BFR information being not indicated, a piece of BFR information immediately following the first BFR information is the BFR information that is associated with an RS resource subgroup in an RS resource group other than the first RS resource group in the first RS resource set.

In one subembodiment, if the first BFR information is a first piece of BFR information in the target MAC CE, the first BFR information is not indicated: if the first BFR information is not the first piece of BFR information in the target MAC CE, the first BFR information is indicated.

In one subembodiment, if one piece of BFR information is a first piece of BFR information in the target MAC CE and the other piece of BFR information is not the first piece of BFR information in the target MAC CE, the one piece of BFR information is before the other piece of BFR information.

In one subembodiment, a first sub-field in a third field of the first BFR information indicates the first RS resource subgroup, a second sub-field in the third field of the first BFR information indicates that the second RS resource subgroup has BFR, and a first sub-field in a third field of the second BFR information indicates the second RS resource subgroup, and a second sub-field in the third field of the second BFR information indicates that the first RS resource group does not include another RS resource subgroup with BFR and the BFR information being not indicated; where the first RS resource group includes the first RS resource subgroup and the second RS resource subgroup, where the first RS resource subgroup has BFR and the second RS resource subgroup has BFR, the first BFR information being located before the second BFR information.

In one subembodiment, a first sub-field in a third field of the second BFR information indicates the second RS resource subgroup, a second sub-field in the third field of the second BFR information indicates that the first RS resource subgroup has BFR, and a first sub-field in a third field of the first BFR information indicates the first RS resource subgroup, and a second sub-field in the third field of the first BFR information indicates that the first RS resource group does not include another RS resource subgroup with BFR and the BFR information being not indicated; where the first RS resource group includes the first RS resource subgroup and the second RS resource subgroup, where the first RS resource subgroup has BFR and the second RS resource subgroup has BFR, the first BFR information being located after the second BFR information.

In one subembodiment, a first sub-field in a third field of the first BFR information indicates the first RS resource subgroup, and a second sub-field in the third field of the first BFR information indicates that the first RS resource group does not include another RS resource subgroup with BFR and the BFR information being not indicated; where the first RS resource group includes the first RS resource subgroup and the second RS resource subgroup, where the first RS resource subgroup has BFR and the second RS resource subgroup has no BFR.

In one embodiment, the first BFR information comprises a first field, a second field and a third field, the third field comprising a first sub-field and a second sub-field; the first field in the first BFR information is used to indicate whether the second field in the first BFR information exists, if the first field in the first BFR information indicates that the second field in the first BFR information exists, the second field in the first BFR information indicates a first RS resource, the first RS resource being associated with the first RS resource subgroup; if the first field in the first BFR information indicates that the second field in the first BFR information does not exist, the second field in the first BFR information is reserved; the first sub-field in the third field of the first BFR information indicates the first RS resource subgroup, and the second sub-field in the third field is used to indicate whether the first RS resource group also includes another RS resource subgroup with BFR.

In one embodiment, the first BFR information comprises a first field, a second field and a third field; the first field in the first BFR information is used to indicate whether the second field in the first BFR information exists, if the first field in the first BFR information indicates that the second field in the first BFR information exists, the second field in the first BFR information indicates a first RS resource, the first RS resource being associated with the first RS resource subgroup; if the first field in the first BFR information indicates that the second field in the first BFR information does not exist, the second field in the first BFR information is reserved; the third field in the first BFR information is reserved.

In one embodiment, the first BFR information comprises a first field, a second field and a third field; the first field in the first BFR information is used to indicate whether the second field in the first BFR information exists, if the first field in the first BFR information indicates that the second field in the first BFR information exists, the second field in the first BFR information indicates a first RS resource, the first RS resource being associated with the first RS resource subgroup; if the first field in the first BFR information indicates that the second field in the first BFR information does not exist, the second field in the first BFR information is reserved; the third field in the first BFR information is used to indicate the first RS resource subgroup.

### Embodiment 17

Embodiment 17 illustrates a schematic diagram of first BFR information comprising a first field, a second field and a third field according to one embodiment of the present application, as shown in FIG. 17.

In the FIG. 17, the first BFR information comprises a first field, a second field and a third field; the box 1701 is the first field, the box 1702 is the third field, and the box 1703 is the second field.

In one embodiment, a length of the first field is 1 bit, a length of the third field is 1 bit, and a length of the second field is 6 bits.

In one embodiment, a length of the first field is 1 bit, a length of the third field is 2 bits, and a length of the second field is 5 bits.

In one embodiment, a sum of the length of the first field, the length of the second field and the length of the third field is equal to 1 byte.

In one embodiment, a sum of the length of the first field, the length of the second field and the length of the third field is equal to 2 bytes.

### Embodiment 18

Embodiment 18 illustrates a schematic diagram of a target MAC CE comprising the first bitmap and at least one piece of BFR information according to one embodiment of the present application, as shown in FIG. 18. In the FIG. 18, the box 1801 represents a first bitmap and the box 1802 represents at least one piece of BFR information.

In Embodiment 18, the target MAC CE comprises the first bitmap and at least one piece of BFR information.

In one embodiment, the at least one piece of BFR information is closely behind the first bitmap.

In one embodiment, the at least one piece of BFR information is set in the box 1802 in accordance with the Q1 pieces of sorted BFR information as described in the Embodiment 19 in this application.

In one embodiment, the at least one piece of BFR information are the Q1 pieces of sorted BFR information.

In one embodiment, the box 1802 includes the Q1 pieces of sorted BFR information.

In one embodiment, the box 1802 includes the at least one piece of BFR information being sorted.

In one embodiment, the box 1802 includes the at least one piece of BFR information being sorted. according to the first criterion in the present application.

In one embodiment, the at least one piece of BFR information includes at least the first BFR information.

### Embodiment 19

Embodiment 19 illustrates a schematic diagram of sorting order of at least one piece of BFR information in a target MAC CE according to one embodiment of the present application, as shown in FIG. 19. In FIG. 19, the target MAC CE includes min{Q1, Q} pieces of BFR information, each box representing one piece of BFR information, including, from front to back, a 1st BFR information field, a 2nd BFR information field, . . . , a last BFR information field, respectively.

In one embodiment, the dashed-line box 1902, dashed-line box 1903, and dashed-line box 1904 are present.

In one embodiment, at least one of the dashed-line box 1902, the dashed-line box 1903 or the dashed-line box 1904 is not present.

In one embodiment, the 1st BFR information field is located before the 2nd BFR information field, the 2nd BFR information field is located before the 3rd BFR information field, . . . and so on with the min{Q1, Q}-th BFR information field.

In one embodiment, the min{Q1, Q}-th BFR information is a last piece of BFR information in the target MAC CE.

In one embodiment, all RS resource subgroups in the first RS resource set correspond to Q1 pieces of BFR information, and each piece of BFR information of the Q1 pieces of BFR information is associated with an RS resource subgroup.

In one embodiment, the min{Q1, Q} pieces of BFR information are determined from the Q1 pieces of BFR information according to the first criterion.

In one embodiment, sorting Q1 pieces of BFR information according to a first criterion, the min{Q1, Q} pieces of sorted BFR information can be obtained.

In one embodiment, determining which BFR information is included in the target MAC CE according to the min{Q1, Q} based on the Q1 pieces of sorted BFR information.

In one embodiment, determining which BFR information is included in the 1st BFR information field, the 2nd BFR information field, . . . , the min{Q1, Q}-th BFR information field in the target MAC CE, in accordance with the min{Q1, Q} pieces of sorted BFR information.

In one embodiment, based on a size of the first uplink grant, if the Q1 pieces of BFR information can be contained in the target MAC CE, the target MAC CE includes the Q1 pieces of sorted BFR information.

In one embodiment, based on a size of the first uplink grant, if the target MAC CE can contain up to Q pieces of BFR information, where Q is less than Q1, the target MAC CE includes the first Q pieces of BFR information in the Q1 pieces of sorted BFR information.

In one embodiment, the phrase that “whether there is one RS resource subgroup without BFR included in the first RS resource group is used to determine the first RS resource subgroup” includes: determining the first RS resource subgroup according to whether the first RS resource group includes one RS resource subgroup without BFR.

In one subembodiment, if there exists at least one RS resource group in the target RS resource set comprising one RS resource subgroup without BFR, the first RS resource group is an RS resource group of the at least one RS resource group in the target RS resource set; the first RS resource subgroup is an RS resource subgroup in the first RS resource group.

In one subembodiment, if there exists at least one RS resource group in the target RS resource set not comprising one RS resource subgroup without BFR, the first RS resource group is an RS resource group of the at least one RS resource group in the target RS resource set; the first RS resource subgroup is an RS resource subgroup in the first RS resource group.

In one embodiment, the phrase that “a number of RS resource subgroups in the first RS resource group is used to determine the first RS resource subgroup” includes: determining the first RS resource subgroup according to the number of RS resource subgroups included in the first RS resource group.

In one subembodiment, the first RS resource group is an RS resource group with the lowest number of RS resource subgroups in a target RS resource set; the first RS resource subgroup is an RS resource subgroup in the first RS resource group.

In one subembodiment, the first RS resource group is an RS resource group having the highest number of RS resource subgroups in a target RS resource set.

In one embodiment, the phrase that “a cell identifier of a cell associated with the first RS resource group is used to determine the first RS resource subgroup” includes: determining the first RS resource subgroup based on the cell identifier of the cell associated with the first RS resource group.

In one subembodiment, the first RS resource subgroup is an RS resource subgroup in one RS resource group that is associated with a cell with a smallest cell identifier in a target RS resource set.

In one subembodiment, the first RS resource subgroup is an RS resource subgroup in one RS resource group that is associated with a cell with a largest cell identifier in a target RS resource set.

In one embodiment, the target RS resource set comprises the first RS resource set.

In one embodiment, the target RS resource set is a subset of the first RS resource set.

In one embodiment, the target RS resource set belongs to the first RS resource set.

In one embodiment, if the first RS resource subgroup is an RS resource subgroup associated with the jj-th piece of BFR information in the target MAC CE, the target RS resource set includes RS resource subgroups in the first RS resource set other than jj-1 RS resource subgroup(s) being associated with the first jj-1 piece(s) of BFR information in the target MAC CE, where jj is a positive integer no greater than min{Q1, Q}.

In one embodiment, the first RS resource subgroup is an RS resource subgroup being associated with a 1st piece of BFR information in the target MAC CE.

In one embodiment, the first RS resource subgroup is an RS resource subgroup being associated with a 2nd piece of BFR information in the target MAC CE.
. . .
and so on.

In one embodiment, the first RS resource subgroup is an RS resource subgroup being associated with a min{Q1, Q}-th piece of BFR information in the target MAC CE.

In one embodiment, if in the target RS resource set there exists an RS resource group which includes one RS resource subgroup without BFR, and in which the number of RS resource subgroup(s) included is equal to 1, and of which an associated cell has the smallest cell identifier, the first RS resource group is the RS resource group; otherwise, if in the target RS resource set there exists an RS resource group which includes one RS resource subgroup without BFR, and in which the number of RS resource subgroup(s) included is equal to 2, and of which an associated cell has the smallest cell identifier, the first RS resource group is the RS resource group; otherwise, if in the target RS resource set there exists an RS resource group which does not include one RS resource subgroup without BFR, and in which the number of RS resource subgroup(s) included is equal to 1, and of which an associated cell has the smallest cell identifier, the first RS resource group is the RS resource group; otherwise, if in the target RS resource set there exists an RS resource group which does not include one RS resource subgroup without BFR, and in which the number of RS resource subgroup(s) included is equal to 2, and of which an associated cell has the smallest cell identifier, the first RS resource group is the RS resource group.

In one embodiment, if in the target RS resource set there exists an RS resource group which includes one RS resource subgroup without BFR, and in which the number of RS resource subgroup(s) included is equal to 2, and of which an associated cell has the smallest cell identifier, the first RS resource group is the RS resource group; otherwise, if in the target RS resource set there exists an RS resource group which includes one RS resource subgroup without BFR, and in which the number of RS resource subgroup(s) included is equal to 1, and of which an associated cell has the smallest cell identifier, the first RS resource group is the RS resource group; otherwise, if in the target RS resource set there exists an RS resource group which does not include one RS resource subgroup without BFR, and in which the number of RS resource subgroup(s) included is equal to 2, and of which an associated cell has the smallest cell identifier, the first RS resource group is the RS resource group; otherwise, if in the target RS resource set there exists an RS resource group which does not include one RS resource subgroup without BFR, and in which the number of RS resource subgroup(s) included is equal to 1, and of which an associated cell has the smallest cell identifier, the first RS resource group is the RS resource group.

In one embodiment, if in the target RS resource set there exists an RS resource group which does not include one RS resource subgroup without BFR, and in which the number of RS resource subgroup(s) included is equal to 1, and of which an associated cell has the smallest cell identifier, the first RS resource group is the RS resource group; otherwise, if in the target RS resource set there exists an RS resource group which does not include one RS resource subgroup without BFR, and in which the number of RS resource subgroup(s) included is equal to 2, and of which an associated cell has the smallest cell identifier, the first RS resource group is the RS resource group: otherwise, if in the target RS resource set there exists an RS resource group which includes one RS resource subgroup without BFR, and in which the number of RS resource subgroup(s) included is equal to 1, and of which an associated cell has the smallest cell identifier, the first RS resource group is the RS resource group; otherwise, if in the target RS resource set there exists an RS resource group which includes one RS resource subgroup without BFR, and in which the number of RS resource subgroup(s) included is equal to 2, and of which an associated cell has the smallest cell identifier, the first RS resource group is the RS resource group.

In one embodiment, if in the target RS resource set there exists an RS resource group which does not include one RS resource subgroup without BFR, and in which the number of RS resource subgroup(s) included is equal to 2, and of which an associated cell has the smallest cell identifier, the first RS resource group is the RS resource group; otherwise, if in the target RS resource set there exists an RS resource group which does not include one RS resource subgroup without BFR, and in which the number of RS resource subgroup(s) included is equal to 1, and of which an associated cell has the smallest cell identifier, the first RS resource group is the RS resource group; otherwise, if in the target RS resource set there exists an RS resource group which includes one RS resource subgroup without BFR, and in which the number of RS resource subgroup(s) included is equal to 2, and of which an associated cell has the smallest cell identifier, the first RS resource group is the RS resource group; otherwise, if in the target RS resource set there exists an RS resource group which includes one RS resource subgroup without BFR, and in which the number of RS resource subgroup(s) included is equal to 1, and of which an associated cell has the smallest cell identifier, the first RS resource group is the RS resource group.

In one embodiment, if there exists in the target RS resource set an RS resource group which does not include one RS resource subgroup without BFR and of which an associated cell has the smallest cell identifier, the first RS resource group is the RS resource group; otherwise, if there exists in the target RS resource set an RS resource group which includes one RS resource subgroup without BFR and of which an associated cell has the smallest cell identifier, the first RS resource group is the RS resource group.

In one embodiment, if there exists in the target RS resource set an RS resource group which includes one RS resource subgroup without BFR and of which an associated cell has the smallest cell identifier, the first RS resource group is the RS resource group; otherwise, if there exists in the target RS resource set an RS resource group which does not include one RS resource subgroup without BFR and of which an associated cell has the smallest cell identifier, the first RS resource group is the RS resource group.

In one embodiment, the first criterion comprises: for at least two pieces of BFR information that are respectively associated with at least two RS resource subgroups in a same RS resource group, sorting the BFR information in accordance with the priority of the at least two RS resource subgroups.

In one embodiment, the first criterion comprises:
if the target RS resource set includes only one RS resource group,
the first RS resource group is the RS resource group, and the first RS resource subgroup is an RS resource subgroup in the first RS resource group;
if the target RS resource set includes at least two RS resource groups,
if all RS resource subgroups in at least one RS resource group in the target RS resource set have BFRs, and at least one RS resource group in the target RS resource set includes one RS resource subgroup without BFR,
if there are at least two RS resource groups comprising unequal numbers of RS resource subgroups among all RS resource groups in which all RS resource subgroups have BFRs in the target RS resource set;
the first RS resource group is an RS resource group having the highest number of RS resource subgroups and being associated with a cell with the smallest cell identifier among all RS resource groups in which all RS resource subgroups have BFRs in the target RS resource set, the first RS resource subgroup being an RS resource subgroup in the first RS resource group;
if there are at least two RS resource groups comprising equal numbers of RS resource subgroups among all RS resource groups in which all RS resource subgroups have BFRs in the target RS resource set;
the first RS resource group is an RS resource group being associated with a cell with the smallest cell identifier among all RS resource groups in which all RS resource subgroups have BFRs in the target RS resource set, the first RS resource subgroup being an RS resource subgroup in the first RS resource group;
if each RS resource subgroup in each RS resource group in the target RS resource set has a BFR,
if there are at least two RS resource groups comprising unequal numbers of RS resource subgroups in the target RS resource set,
the first RS resource group is an RS resource group having the highest number of RS resource subgroups and being associated with a cell with the smallest cell identifier in the target RS resource set, the first RS resource subgroup being an RS resource subgroup in the first RS resource group;
if there are at least two RS resource groups comprising equal numbers of RS resource subgroups in the target RS resource set,
the first RS resource group is an RS resource group being associated with a cell with the smallest cell identifier in the target RS resource set, the first RS resource subgroup being an RS resource subgroup in the first RS resource group.

In one embodiment, the first RS resource subgroup is determined from the first RS resource set according to the first criterion, the first BFR information associated with the first RS resource subgroup being a 1st piece of BFR information in the target MAC CE.

In one embodiment, the first RS resource subgroup is determined from a target RS resource set according to the first criterion, the first BFR information associated with the first RS resource subgroup being a 2nd piece of BFR information in the target MAC CE, the target RS resource set comprising RS resource subgroups in the first RS resource set other than an RS resource subgroup associated with the 1st piece of BFR information.

In one embodiment, the first RS resource subgroup is determined from a target RS resource set according to the first criterion, the first BFR information associated with the first RS resource subgroup being a 3rd piece of BFR information in the target MAC CE, the target RS resource set comprising RS resource subgroups in the first RS resource set other than an RS resource subgroup associated with the 1st piece of BFR information and an RS resource subgroup associated with the 2nd piece of BFR information. and so on.

In one embodiment, at least whether the first RS resource group includes an RS resource subgroup without BFR, the number of RS resource subgroups included in the first RS resource group and a cell identifier of a cell associated with the first RS resource group are used to determine the first RS resource subgroup.

In one embodiment, at least whether the first RS resource group includes an RS resource subgroup without BFR and a cell identifier of a cell associated with the first RS resource group are used to determine the first RS resource subgroup.

In one embodiment, at least whether the first RS resource group includes an RS resource subgroup without BFR, the number of RS resource subgroups included in the first RS resource group and a cell identifier of a cell associated with the first RS resource group are used to determine the first criterion.

In one embodiment, the first criterion comprises: determining the order of the at least one piece of BFR information in the target MAC CE firstly according to “whether the first RS resource group includes an RS resource subgroup without BFR”, then according to “the number of RS resource subgroups included in the first RS resource group”, and finally according to “a cell identifier of a cell associated with the first RS resource group”.

In one embodiment, the first criterion comprises: determining the order of the at least one piece of BFR information in the target MAC CE firstly according to “the number of RS resource subgroups included in the first RS resource group”, then according to “whether the first RS resource group includes an RS resource subgroup without BFR”, and finally according to “a cell identifier of a cell associated with the first RS resource group”.

In one embodiment, the first criterion comprises: determining the order of the at least one piece of BFR information in the target MAC CE firstly according to “whether the first RS resource group includes an RS resource subgroup without BFR”, and then according to “a cell identifier of a cell associated with the first RS resource group”.

In one embodiment, the first criterion is only given for illustrating the practical effect and as a way of implementation, and the present application is not limited to the above way of implementation.

In one embodiment, to illustrate the technical effect of the present application, in Table 1, it is assumed that the first RS resource set comprises 6 RS resource groups, each RS resource group comprising at most 2 RS resource subgroups, and each row in the Table 1 corresponds to an RS resource group; the first column represents cell identifiers of cells respectively associated with each RS resource group in the first RS resource set, where a, b, c, d, e, f are all positive integers, and a is less than b, b is less than c, c is less than d, d is less than e, and e is less than f; the second column indicates the numbers of RS resource subgroups respectively included in each RS resource group in the first RS resource set, with 1 indicating that the number of RS resource subgroups included in an RS resource group is equal to 1, 2 indicating that the number of RS resource subgroups included in an RS resource group is equal to 2; the third column indicates whether each RS resource group in the first RS resource set includes an RS resource subgroup without BFR; “yes” indicates that an RS resource group includes an RS resource subgroup without BFR, while “no” indicates that an RS resource group does not include an RS resource subgroup without BFR; and the fourth column indicates BFR information being associated with each RS resource subgroup in each RS resource group in the first RS resource set.

In one subembodiment, in the Table 1, Q1 is equal to 8.

In one subembodiment, if Q is not less than 8, the target MAC CE includes the 8 pieces of sorted BFR information.

In one subembodiment, if Q is less than 8, the target MAC CE includes the first Q pieces of BFR information among the 8 pieces of sorted BFR information.

TABLE 1

| | | C | |
|---|---|---|---|
| | B | Whether an RS | |
| | The number of RS | resource subgroup | |
| A | resource | without BFR is | |
| Cell | subgroups per RS | included in an RS | D |
| identifier | resource group | resource group | BFR info |
| a | 2 | Yes | BFR info #a |
| b | 1 | No | BFR info #b |
| c | 2 | No | BFR info #c.1 |
| | | | BFR info #c.2 |
| d | 1 | No | BFR info #d |
| e | 2 | No | BFR info #e.1 |
| | | | BFR info #e.2 |
| f | 2 | Yes | BFR info #f |

In one embodiment, the first criterion comprises: determining the order of the at least one piece of BFR information in the target MAC CE firstly according to “whether the first RS resource group includes an RS resource subgroup without BFR”, and finally according to “a cell identifier of a cell associated with the first RS resource group”; where an RS resource group not including an RS resource subgroup without BFR takes precedence over an RS resource group including an RS resource subgroup without BFR, the numbers of RS resource subgroups in the RS resource groups are sorted in descending order, and the cell identifiers are sorted in ascending order.

In one subembodiment, for the Table 1, the following 8 pieces of sorted BFR information are obtained: BFR info #b, BFR info #c.1, BFR info #c.2, BFR info #d, BFR info #e.1, BFR info #e.2, BFR info #a, and BFR info #f.

In one embodiment, the first criterion comprises: determining the order of the at least one piece of BFR information in the target MAC CE firstly according to “whether the first RS resource group includes an RS resource subgroup without BFR”, then according to “the number of RS resource subgroups included in the first RS resource group”, and finally according to “a cell identifier of a cell associated with the first RS resource group”; where an RS resource group not including an RS resource subgroup without BFR takes precedence over an RS resource group including an RS resource subgroup without BFR, the numbers of RS resource subgroups in the RS resource groups are sorted in descending order, and the cell identifiers are sorted in ascending order.

In one subembodiment, for the Table 1, the following 8 pieces of sorted BFR information are obtained: BFR info #c.1, BFR info #c.2, BFR info #e.1, BFR info #e.2, BFR info #b, BFR info #d, BFR info #a, and BFR info #f.

In one embodiment, the first criterion comprises: determining the order of the at least one piece of BFR information in the target MAC CE firstly according to “whether the first RS resource group includes an RS resource subgroup without BFR”, then according to “the number of RS resource subgroups included in the first RS resource group”, and finally according to “a cell identifier of a cell associated with the first RS resource group”; where an RS resource group not including an RS resource subgroup without BFR takes precedence over an RS resource group including an RS resource subgroup without BFR, the numbers of RS resource subgroups in the RS resource groups are sorted in ascending order, and the cell identifiers are sorted in ascending order.

In one subembodiment, for the Table 1, the following 8 pieces of sorted BFR information are obtained: BFR info #b, BFR info #d, BFR info #c.1, BFR info #c.2, BFR info #e.1, BFR info #e.2, BFR info #a, and BFR info #f.

In one embodiment, the first criterion comprises: determining the order of the at least one piece of BFR information in the target MAC CE firstly according to “whether the first RS resource group includes an RS resource subgroup without BFR”, then according to “the number of RS resource subgroups included in the first RS resource group”, and finally according to “a cell identifier of a cell associated with the first RS resource group”; where an RS resource group including an RS resource subgroup without BFR takes precedence over an RS resource group not including an RS resource subgroup without BFR, the numbers of RS resource subgroups in the RS resource groups are sorted in descending order, and the cell identifiers are sorted in ascending order.

In one subembodiment, for the Table 1, the following 8 pieces of sorted BFR information are obtained: BFR info #a, BFR info #f, BFR info #c.1, BFR info #c.2, BFR info #e.1, BFR info #e.2, BFR info #b, and BFR info #d.

In one embodiment, the first criterion comprises: determining the order of the at least one piece of BFR information in the target MAC CE firstly according to “whether the first RS resource group includes an RS resource subgroup without BFR”, then according to “the number of RS resource subgroups included in the first RS resource group”, and finally according to “a cell identifier of a cell associated with the first RS resource group”: where an RS resource group including an RS resource subgroup without BFR takes precedence over an RS resource group not including an RS resource subgroup without BFR, the numbers of RS resource subgroups in the RS resource groups are sorted in ascending order, and the cell identifiers are sorted in ascending order.

In one subembodiment, for the Table 1, the following 8 pieces of sorted BFR information are obtained: BFR info #a, BFR info #f, BFR info #b, BFR info #d, BFR info #c.1, BFR info #c.2, BFR info #e.1, and BFR info #e.2.

In one embodiment, to illustrate the technical effect of the present application, in Table 2, it is assumed that the first RS resource set comprises 4 RS resource groups, each RS resource group comprising at least 2 RS resource subgroups, and each row in the Table 2 corresponds to an RS resource group; the first column represents cell identifiers of cells respectively associated with each RS resource group in the first RS resource set, where aa, bb, cc, dd are all positive integers, and aa is less than bb, bb is less than cc, cc is less than dd; the second column indicates whether each RS resource group in the first RS resource set includes an RS resource subgroup without BFR; “yes” indicates that an RS resource group includes an RS resource subgroup without BFR, while “no” indicates that an RS resource group does not include an RS resource subgroup without BFR; and the fourth column indicates BFR information being associated with each RS resource subgroup in each RS resource group in the first RS resource set.

In one subembodiment, each RS resource group includes 2 RS resource subgroups.

In one subembodiment, each RS resource group includes 2 or more than 2 RS resource subgroups.

In one subembodiment, in the Table 1, Q1 is equal to 6.

In one subembodiment, if Q is not less than 6, the target MAC CE includes the 6 pieces of sorted BFR information.

In one subembodiment, if Q is less than 6, the target MAC CE includes the first Q pieces of BFR information among the 6 pieces of sorted BFR information.

TABLE 2

| Cell | Whether an RS resource subgroup without | |
|---|---|---|
| identifier | BFR is included in an RS resource group | BFR info |
| aa | Yes | BFR info #aa |
| bb | No | BFR info #bb.1 |
| | | BFR info #bb.2 |
| cc | No | BFR info #cc.1 |
| | | BFR info #cc.2 |
| dd | Yes | BFR info #dd |

In one embodiment, the first criterion comprises: determining the order of the at least one piece of BFR information in the target MAC CE firstly according to “whether the first RS resource group includes an RS resource subgroup without BFR”, and then according to “a cell identifier of a cell associated with the first RS resource group”; where an RS resource group not including an RS resource subgroup without BFR takes precedence over an RS resource group including an RS resource subgroup without BFR, and the cell identifiers are sorted in ascending order.

In one subembodiment, for the Table 2, the following 6 pieces of sorted BFR information are obtained: BFR info #bb.1, BFR info #bb.2, BFR info #cc.1, BFR info #cc.2, BFR info #aa, and BFR info #dd.

In one embodiment, the first criterion comprises: determining the order of the at least one piece of BFR information in the target MAC CE firstly according to “whether the first RS resource group includes an RS resource subgroup without BFR”, and then according to “a cell identifier of a cell associated with the first RS resource group”; where an RS resource group including an RS resource subgroup without BFR takes precedence over an RS resource group not including an RS resource subgroup without BFR, and the cell identifiers are sorted in ascending order.

In one subembodiment, for the Table 2, the following 6 pieces of sorted BFR information are obtained: BFR info #aa, BFR info #dd, BFR info #bb.1, BFR info #bb.2, BFR info #cc.1, and BFR info #cc.2.

### Embodiment 20

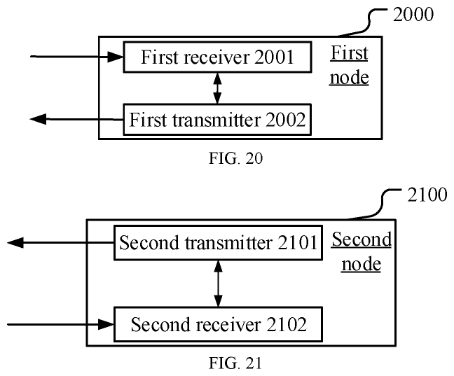

Embodiment 20 illustrates a structure block diagram of a processing device used in a first node according to one embodiment of the present application, as shown in FIG. 20. In FIG. 20, a processing device 2000 in a first node is comprised of a first receiver 2001 and a first transmitter 2002.

The first receiver 2001 receives a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; for each RS resource subgroup in the first RS resource set, whenever a radio link quality evaluated according to the each RS resource subgroup is worse than a first-type threshold, incrementing a first-class counter corresponding to the each RS resource subgroup by 1: determining whether to trigger a Beam Failure Recovery (BFR) according to whether the first-class counter corresponding to the each RS resource subgroup reaches a first-type value; and receiving a second signaling, the second signaling indicating a first uplink grant;
the first transmitter 2002 transmits a target MAC CE according to the first uplink grant, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set.

In Embodiment 20, there is at least one RS resource subgroup with BFR in each RS resource group in the first RS resource set: at least whether there is one RS resource subgroup without BFR included in the first RS resource group is used to determine the first RS resource subgroup.

In one embodiment, a number of RS resource subgroups in the first RS resource group is used to determine the first RS resource subgroup.

In one embodiment, a cell identifier of a cell associated with the first RS resource group is used to determine the first RS resource subgroup.

In one embodiment, the first BFR information is a last piece of BFR information in the at least one piece of BFR information: resources granted by the first uplink grant can contain up to Q pieces of BFR information, Q being a positive integer, Q being used to determine the first RS resource subgroup.

In one embodiment, the first BFR information is a piece of BFR information at any given position in the at least one piece of BFR information.

In one embodiment, the target MAC CE comprises a first bitmap, a first bit in the first bitmap indicates the first RS resource subgroup or the first bit in the first bitmap indicates a cell associated with the first RS resource group.

In one embodiment, the first BFR information comprises at least one of a first field, a second field or a third field; the first field in the first BFR information is used to indicate whether the second field in the first BFR information exists, if the first field in the first BFR information indicates that the second field in the first BFR information exists, the second field in the first BFR information indicates a first RS resource, the first RS resource being associated with the first RS resource subgroup; if the first field in the first BFR information indicates that the second field in the first BFR information does not exist, the second field in the first BFR information is reserved; the third field in the first BFR information is reserved or the third field in the first BFR information is used to indicate the first RS resource subgroup.

In one embodiment, the first receiver 2001 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 2001 comprises the antenna 452, the receiver 454, the multi-antenna receiving processor 458 and the receiving processor 456 in FIG. 4 of the present application.

In one embodiment, the first receiver 2001 comprises the antenna 452, the receiver 454 and the receiving processor 456 in FIG. 4 of the present application.

In one embodiment, the first transmitter 2002 comprises the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 2002 comprises the antenna 452, the transmitter 454, the multi-antenna transmitting processor 457 and the transmitting processor 468 in FIG. 4 of the present application.

In one embodiment, the first transmitter 2002 comprises the antenna 452, the transmitter 454 and the transmitting processor 468 in FIG. 4 of the present application.

### Embodiment 21

Embodiment 21 illustrates a structure block diagram of a processing device used in a second node according to one embodiment of the present application, as shown in FIG. 21. In FIG. 21, a processing device 2100 in a second node is comprised of a second transmitter 2101 and a second receiver 2102.

The second transmitter 2101 transmits a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource: and transmitting a second signaling, the second signaling indicating a first uplink grant:
the second receiver 2102 receives a target MAC CE, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set.

In Embodiment 21, for each RS resource subgroup in the first RS resource set, whenever a radio link quality evaluated according to the each RS resource subgroup is worse than a first-type threshold, a first-class counter corresponding to the each RS resource subgroup is incremented by 1; it is determined whether a BFR is to be triggered according to whether the first-class counter corresponding to the each RS resource subgroup reaches a first-type value; the target MAC CE is transmitted according to the first uplink grant; there is at least one RS resource subgroup with BFR in each RS resource group in the first RS resource set; at least whether there is one RS resource subgroup without BFR included in the first RS resource group is used to determine the first RS resource subgroup.

In one embodiment, a number of RS resource subgroups in the first RS resource group is used to determine the first RS resource subgroup.

In one embodiment, a cell identifier of a cell associated with the first RS resource group is used to determine the first RS resource subgroup.

In one embodiment, the first BFR information is a last piece of BFR information in the at least one piece of BFR information: resources granted by the first uplink grant can contain up to Q pieces of BFR information, Q being a positive integer, Q being used to determine the first RS resource subgroup.

In one embodiment, the first BFR information is a piece of BFR information at any given position in the at least one piece of BFR information.

In one embodiment, the target MAC CE comprises a first bitmap, a first bit in the first bitmap indicates the first RS resource subgroup or the first bit in the first bitmap indicates a cell associated with the first RS resource group.

In one embodiment, the first BFR information comprises at least one of a first field, a second field or a third field; the first field in the first BFR information is used to indicate whether the second field in the first BFR information exists, if the first field in the first BFR information indicates that the second field in the first BFR information exists, the second field in the first BFR information indicates a first RS resource, the first RS resource being associated with the first RS resource subgroup; if the first field in the first BFR information indicates that the second field in the first BFR information does not exist, the second field in the first BFR information is reserved; the third field in the first BFR information is reserved or the third field in the first BFR information is used to indicate the first RS resource subgroup.

In one embodiment, the second transmitter 2101 comprises the antenna 420, the transmitter 418, the multi-antenna transmitting processor 471, the transmitting processor 416, the controller/processor 475 and the memory 476 in FIG. 4 of the present application.

In one embodiment, the second transmitter 2101 comprises the antenna 420, the transmitter 418, the multi-antenna transmitting processor 471 and the transmitting processor 416 in FIG. 4 of the present application.

In one embodiment, the second transmitter 2101 comprises the antenna 420, the transmitter 418 and the transmitting processor 416 in FIG. 4 of the present application.

In one embodiment, the second receiver 2102 comprises the antenna 420, the receiver 418, the multi-antenna receiving processor 472, the receiving processor 470, the controller/processor 475 and the memory 476 in FIG. 4 of the present application.

In one embodiment, the second receiver 2102 comprises the antenna 420, the receiver 418, the multi-antenna receiving processor 472 and the receiving processor 470 in FIG. 4 of the present application.

In one embodiment, the second receiver 2102 comprises the antenna 420, the receiver 418 and the receiving processor 470 in FIG. 4 of the present application.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; for each RS resource subgroup in the first RS resource set, whenever a radio link quality evaluated according to the each RS resource subgroup is worse than a first-type threshold, incrementing a first-class counter corresponding to the each RS resource subgroup by 1; determining whether to trigger a Beam Failure Recovery (BFR) according to whether the first-class counter corresponding to the each RS resource subgroup reaches a first-type value; and receiving a second signaling, the second signaling indicating a first uplink grant; and
a first transmitter, transmitting a target MAC CE according to the first uplink grant, the target MAC CE comprising at least one piece of BFR information, first BFR information being one of the at least one piece of BFR information, the first BFR information being associated with a first RS resource subgroup. the first RS resource subgroup being one RS resource subgroup in a first RS resource group, the first RS resource group being one RS resource group in the first RS resource set;
wherein there is at least one RS resource subgroup with BFR in each RS resource group in the first RS resource set; at least whether there is one RS resource subgroup without BFR included in the first RS resource group is used to determine the first RS resource subgroup.

2. The first node according to claim 1. characterized in that a number of RS resource subgroups in the first RS resource group is used to determine the first RS resource subgroup.

3. The first node according to claim 1. characterized in that a cell identifier of a cell associated with the first RS resource group is used to determine the first RS resource subgroup.

4. The first node according to claim 1. characterized in that the first BFR information is a last piece of BFR information in the at least one piece of BFR information; resources granted by the first uplink grant can contain up to Q pieces of BFR information, Q being a positive integer, Q being used to determine the first RS resource subgroup.

5. The first node according to claim 1, characterized in that the first BFR information is a piece of BFR information at any given position in the at least one piece of BFR information.

6. The first node according to claim 1, characterized in that the target MAC CE comprises a first bitmap, a first bit in the first bitmap indicates the first RS resource subgroup or the first bit in the first bitmap indicates a cell associated with the first RS resource group.

7. The first node according to claim 6, characterized in that the first bit in the first bitmap indicates whether the cell associated with the first RS resource group has a BFR; the first bit in the first bitmap being set to 1 indicates that the cell associated with the first RS resource group has a BFR; the first bit in the first bitmap being set to 0 indicates that the cell associated with the first RS resource group has no BFR.

8. The first node according to claim 6, characterized in that the first bitmap comprises a first sub-bitmap and a second sub-bitmap, the first sub-bitmap comprising a first bit, the second sub-bitmap comprising a second bit; the second sub-bitmap is closely behind the first sub-bitmap; the at least one piece of BFR information is closely behind the first bitmap.

9. The first node according to claim 8, characterized in that the first sub-bitmap and the second sub-bitmap are of equal size.

10. The first node according to claim 8, characterized in that the first sub-bitmap and the second sub-bitmap are of unequal sizes.

11. The first node according to claim 8, characterized in that the first bit in the first sub-bitmap indicates the cell associated with the first RS resource group, while the second bit in the second sub-bitmap indicates whether there is one RS resource subgroup without BFR included in the first RS resource group; the first RS resource group comprises two RS resource subgroups.

12. The first node according to claim 8, characterized in that if at least one RS resource subgroup in the first RS resource group has a BFR, the first bit is set to 1, otherwise, the first bit is set to 0; if each RS resource subgroup in the first RS resource group has a BFR, the second bit is set to 1, otherwise, the second bit is set to 0.

13. The first node according to claim 1, characterized in that the first BFR information comprises a first field, a second field and a third field; the first field in the first BFR information is used to indicate whether the second field in the first BFR information exists, if the first field in the first BFR information indicates that the second field in the first BFR information exists, the second field in the first BFR information indicates a first RS resource, the first RS resource being associated with the first RS resource subgroup; if the first field in the first BFR information indicates that the second field in the first BFR information does not exist, the second field in the first BFR information is reserved; the third field in the first BFR information is set to 0.

14. The first node according to claim 1, characterized in that the first BFR information comprises a first field, a second field and a third field; the first field in the first BFR information is used to indicate whether the second field in the first BFR information exists, if the first field in the first BFR information indicates that the second field in the first BFR information exists, the second field in the first BFR information indicates a first RS resource, the first RS resource being associated with the first RS resource subgroup; if the first field in the first BFR information indicates that the second field in the first BFR information does not exist, the second field in the first BFR information is reserved; the third field in the first BFR information is used to indicate the first RS resource subgroup; the third field in the first BFR information indicates an index of the first RS resource subgroup; the third field in the first BFR information is set to 0 or 1.

15. The first node according to claim 13, characterized in that a length of the first field is 1 bit, a length of the third field is 1 bit, and a length of the second field is 6 bits.

16. The first node according to claim 1, characterized in that one RS resource subgroup with BFR or that one RS resource subgroup has a BFR means that; a beam failure is detected for the RS resource subgroup, and an evaluation for candidate beams associated with the RS resource subgroup is completed.

17. The first node according to claim 1, characterized in that numbers of RS resource subgroups in any two RS resource groups in the first RS resource set are equal or unequal.

18. A second node for wireless communications, comprising:
a second transmitter, transmitting a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; and transmitting a second signaling, the second signaling indicating a first uplink grant; and
a second receiver, receiving a target MAC CE, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set;
wherein for each RS resource subgroup in the first RS resource set, whenever a radio link quality evaluated according to the each RS resource subgroup is worse than a first-type threshold, a first-class counter corresponding to the each RS resource subgroup is incremented by 1; it is determined whether a BFR is to be triggered according to whether the first-class counter corresponding to the each RS resource subgroup reaches a first-type value; the target MAC CE is transmitted according to the first uplink grant; there is at least one RS resource subgroup with BFR in each RS resource group in the first RS resource set; at least whether there is one RS resource subgroup without BFR included in the first RS resource group is used to determine the first RS resource subgroup.

19. A method in a first node for wireless communications, comprising:
receiving a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource;
for each RS resource subgroup in the first RS resource set, whenever a radio link quality evaluated according to the each RS resource subgroup is worse than a first-type threshold, incrementing a first-class counter corresponding to the each RS resource subgroup by 1; determining whether to trigger a Beam Failure Recovery (BFR) according to whether the first-class counter corresponding to the each RS resource subgroup reaches a first-type value;
receiving a second signaling, the second signaling indicating a first uplink grant; and transmitting a target MAC CE according to the first uplink grant, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set;
wherein there is at least one RS resource subgroup with BFR in each RS resource group in the first RS resource set; at least whether there is one RS resource subgroup without BFR included in the first RS resource group is used to determine the first RS resource subgroup.

20. A method in a second node for wireless communications, comprising:
transmitting a first signaling, the first signaling indicating a first RS resource set, the first RS resource set comprising at least one RS resource group, each of the at least one RS resource group being associated with one cell, and each of the at least one RS resource group comprising at least one RS resource subgroup, each RS resource subgroup comprising at least one RS resource; and
transmitting a second signaling; the second signaling indicating a first uplink grant; and receiving a target MAC CE, the target MAC CE comprising at least one piece of BFR information, first BFR information being one of the at least one piece of BFR information, the first BFR information being associated with a first RS resource subgroup, the first RS resource subgroup being one RS resource subgroup in a first RS resource group, the first RS resource group being one RS resource group in the first RS resource set;
wherein for each RS resource subgroup in the first RS resource set, whenever a radio link quality evaluated according to the each RS resource subgroup is worse than a first-type threshold, a first-class counter corresponding to the each RS resource subgroup is incremented by 1; it is determined whether a BFR is to be triggered according to whether the first-class counter corresponding to the each RS resource subgroup reaches a first-type value; the target MAC CE is transmitted according to the first uplink grant; there is at least one RS resource subgroup with BFR in each RS resource group in the first RS resource set; at least whether there is one RS resource subgroup without BFR included in the first RS resource group is used to determine the first RS resource subgroup.
